(19) United States
(12) Patent Application Publication
(10) Pub. No.: US 2016/0104491 A1
(43) Pub. Date: Apr. 14, 2016

(54) AUDIO SIGNAL PROCESSING METHOD FOR SOUND IMAGE LOCALIZATION

(71) Applicant: INTELLECTUAL DISCOVERY CO., LTD., Gangnam-gu, Seoul (KR)

(72) Inventors: Taegyu LEE, Seoul (KR); Hyun Oh OH, Seongnam-si (KR); Myungsuk SONG, Seoul (KR); Jeongook SONG, Seoul (KR)

(73) Assignee: INTELLECTUAL DISCOVERY CO., LTD., Gangnam-gu, Seoul (KR)

(21) Appl. No.: 14/787,065

(22) PCT Filed: Apr. 24, 2014
(86) PCT No.: PCT/KR2014/003576

§ 371 Date: Oct. 26, 2015

(30) Foreign Application Priority Data
Apr. 27, 2013 (KR) 10-2013-0047056

(51) Int. Cl. G10L 19/008; H04S 7/00; H04S 3/00

(52) U.S. Cl. CPC G10L 19/008; H04S 3/008; H04S 7/303; H04S 2400/11; H04S 2400/03

(57) ABSTRACT

An audio signal processing method for sound image localization according to the present invention comprises the steps of: receiving a bit sequence including an object signal of an audio and object location information of the audio; decoding the object signal and the object location information using the received bit sequence; receiving past object location information, which is past object location information corresponding to the object location information, from a storage medium; generating an object moving path using the received past object location information and the decoded object location information; generating a variable gain value according to time using the generated object moving path; generating a corrected variable gain value using the generated variable gain value and a weighting function; and generating a channel signal from the decoded object signal using the corrected variable gain value.

### TECHNICAL FIELD

The present invention generally relates to an audio signal processing method for sound image localization and, more particularly, to an audio signal processing method for sound image localization, which encodes and decodes object audio signals, or renders the object audio signals in a three-dimensional (3D) space. This application claims the benefit of Korean Patent Application No. 1020130047056, filed Apr. 27, 2013, which is hereby incorporated by reference in its entirety into this application.

### BACKGROUND ART

3D audio integrally denotes a series of signal processing, transmission, encoding, and reproducing technologies for literally providing sounds with presence in a 3D space by providing another axis (dimension) in the height direction to a sound scene (2D) in a horizontal plane, which is provided by existing surround audio technology. In particular, in order to provide 3D audio, a larger number of speakers than that of conventional technology are used, or alternatively, rendering technology is widely required which forms sound images at virtual positions where speakers are not present, even if a small number of speakers are used.

It is expected that 3D audio will become an audio solution corresponding to an ultra-high definition television (UHDTV), which will be released in the future, and that it will be variously applied to cinema sounds, sounds for a personal 3D television (3DTV), a tablet, a smartphone, and a cloud game, etc. as well as sounds in vehicles, which are evolving into high-quality infotainment spaces.

### DISCLOSURE

### Technical Problem

Three-dimensional (3D) audio technology requires the transmission of signals through a larger number of channels than conventional technology, up to a maximum of 22.2 channels. For this, compression transmission technology suitable for such transmission is required.

Conventional high-quality coding such as MPEG audio layer 3 (MP3), Advanced Audio Coding (AAC), Digital Theater Systems (DTS), and Audio Coding-3 (AC3), was mainly adapted only to the transmission of signals including fewer than 5.1 channels. Further, in order to reproduce 22.2 channel signals, there is an infrastructure for a listening space in which 24-speaker systems are installed, but it is not easy to popularize such an infrastructure on the market in a short period of time. Accordingly, there are required technology for effectively reproducing 22.2 channel signals in a space having fewer speakers than 22.2 channels, technology for, in contrast, reproducing existing stereo or 5.1 channel sound sources in an environment having 10.1 or 22.2 channel speakers, which is more than the existing sound sources, technology for providing sound scenes provided by original sound sources even in places other than an environment having defined speaker positions and defined listening rooms, and technology for reproducing 3D sounds even in a headphone-listening environment. Such technologies are integrally referred to as “rendering” in the present invention, and are more specifically referred to as downmixing, upmixing, flexible rendering, binaural rendering, etc.

Meanwhile, as an alternative for effectively transmitting such a sound scene, an object-based signal transmission scheme is required. Depending on the sound source, it may be more favorable to perform object-based transmission rather than channel-based transmission. In addition, object-based transmission enables interactive listening to a sound source, for example, by allowing a user to freely adjust the reproduction size and position of objects. Accordingly, there is required an effective transmission method capable of compressing object signals at a high transfer rate.

Further, sound sources having a mixed form of channel-based signals and object-based signals may be present, and a new type of listening experience may be provided by means of the sound sources. Therefore, there is also required technology for effectively transmitting together channel signals and object signals and effectively rendering such signals.

Finally, exceptional channels, which are difficult to reproduce using existing schemes, may be present depending on the specialty of channels and the speaker environment in the reproduction stage. In this case, technology for effectively reproducing exceptional channels based on the speaker environment in the reproduction stage is required.

### Technical Solution

An audio signal processing method for sound image localization according to accomplish the above objects includes receiving a bitstream including an object signal of audio and object position information of the audio, decoding the object signal and the object position information using the received bitstream, receiving past object position information that is object position information in the past, corresponding to the object position information, from a storage medium, generating an object moving path using the received past object position information and the decoded object position information, generating a variable gain value over time using the generated object moving path, generating a corrected variable gain value using the generated variable gain value and a weighting function, and generating a channel signal from the decoded object signal using the corrected variable gain value.

The weighting function may vary based on a user's physiological feature.

The physiological feature may be extracted using an image or a video.

The physiological feature may include information about at least one of a size of the user's head, a size of the user's body, and a shape of the user's external ear.

### Advantageous Effects

In accordance with the present invention, the problem of causing continuously moving signals to be discontinuously perceived by a user, contrary to what is intended for the content, is solved. The present invention has the effect of selectively solving this problem using weighting functions suitable for respective users in consideration of the physiological features of the users. The effects of the present invention are not limited to the above-described effects, and effects not described here may be clearly understood by those skilled in the art to which the present invention pertains from the present specification and the attached drawings.

### DESCRIPTION OF DRAWINGS

FIG. 1 is a flowchart showing an audio signal processing method for sound image localization according to the present invention;

FIG. 2 is a diagram showing viewing angles depending on the sizes of an image at the same viewing distance;

FIG. 3 is a configuration diagram showing an arrangement of 22.2 channel speakers as an example of a multichannel environment;

FIG. 4 is a conceptual diagram showing the positions of respective sound objects in a listening space in which a listener listens to 3D audio;

FIG. 5 is an exemplary configuration diagram showing the formation of object signal groups for objects shown in FIG. 4 using a grouping method according to the present invention;

FIG. 6 is a configuration diagram showing an embodiment of an object audio signal encoder according to the present invention;

FIG. 7 is an exemplary configuration diagram of a decoding device according to an embodiment of the present invention;

FIGS. 8 and 9 are diagrams showing examples of a bitstream generated by performing encoding using an encoding method according to the present invention;

FIG. 10 is a block diagram showing an embodiment of an object and channel signal decoding system according to the present invention;

FIG. 11 is a block diagram showing another embodiment of an object and channel signal decoding system according to the present invention;

FIG. 12 illustrates an embodiment of a decoding system according to the present invention;

FIG. 13 is a diagram showing masking thresholds for a plurality of object signals according to the present invention;

FIG. 14 is a diagram showing an embodiment of an encoder for calculating masking thresholds for a plurality of object signals according to the present invention;

FIG. 15 is a diagram showing an arrangement depending on ITUR recommendations and an arrangement at random positions for 5.1 channel setup;

FIGS. 16 and 17 are diagrams showing an embodiment of a structure in which a decoder for an object bitstream and a flexible rendering system using the decoder are connected to each other according to the present invention;

FIG. 18 is a diagram showing another embodiment of a structure in which decoding for an object bitstream and rendering are implemented according to the present invention;

FIG. 19 is a diagram showing a structure for determining a transmission schedule and transmitting objects between a decoder and a renderer;

FIG. 20 is a conceptual diagram showing a concept in which sounds from speakers removed due to a display, among speakers arranged in front positions in a 22.2 channel system, are reproduced using neighboring channels thereof;

FIG. 21 is a diagram showing an embodiment of a processing method for arranging sound sources at the positions of absent speakers according to the present invention;

FIG. 22 is a diagram showing an embodiment of mapping of signals generated in respective bands to speakers arranged around a TV; and

FIG. 23 is a conceptual diagram showing a procedure of downmixing an exceptional signal;

FIG. 24 is a flowchart of a downmixer selection unit;

FIG. 25 is a conceptual diagram showing a simplified method in a matrix-based downmixer;

FIG. 26 is a conceptual diagram of a matrix-based downmixer;

FIG. 27 is a conceptual diagram of a path-based downmixer;

FIG. 28 is a graph showing an example of a weighting function;

FIG. 29 is a conceptual diagram of a detent effect;

FIG. 30 is a conceptual diagram of a virtual channel generator; and

FIG. 31 is a diagram showing the relationship between products in which an audio signal processing device according to an embodiment of the present invention is implemented.

### BEST MODE

The present invention will be described in detail with reference to the attached drawings. In the present specification, detailed descriptions of known configurations and functions related to the present invention which have been deemed to make the gist of the present invention unnecessarily obscure will be omitted below.

Since embodiments described in the present specification are intended to clearly describe the spirit of the present invention to those skilled in the art to which the present invention pertains, the present invention is not limited to those embodiments described in the present specification, and it should be understood that the scope of the present invention includes changes or modifications without departing from the spirit of the invention. The terms and attached drawings used in the present specification are intended to easily describe the present invention, and shapes shown in the drawings are exaggerated to help the understanding of the present invention if necessary, and thus the present invention is not limited by the terms used in the present specification and the attached drawings.

In the present specification, detailed descriptions of known configurations or functions related to the present invention which have been deemed to make the gist of the present invention unnecessarily obscure will be omitted below. In the present invention, the following terms may be construed based on the following criteria, and even terms not described in the present specification may be construed according to the following gist.

“Coding” may be construed as encoding or decoding according to the circumstances, and “information” is a term encompassing values, parameters, coefficients, elements, etc., and may be differently construed depending on the circumstances, but the present invention is not limited thereto.

In accordance with an aspect of the present invention, an audio signal processing method includes receiving a bitstream including an object signal of audio and object position information of the audio, decoding the object signal and the object position information using the received bitstream, receiving past object position information that is object position information in the past, corresponding to the object position information, from a storage medium, generating an object moving path using the received past object position information and the decoded object position information, generating a variable gain value over time using the generated object moving path, generating a corrected variable gain value using the generated variable gain value and a weighting function, and generating a channel signal from the decoded object signal using the corrected variable gain value.

The weighting function may vary based on a user's physiological feature.

The physiological feature may be extracted using an image or a video.

The physiological feature may include information about at least one of a size of the user's head, a size of the user's body, and a shape of the user's external ear.

Hereinafter, an audio signal processing method for sound image localization according to embodiments of the present invention will be described in detail.

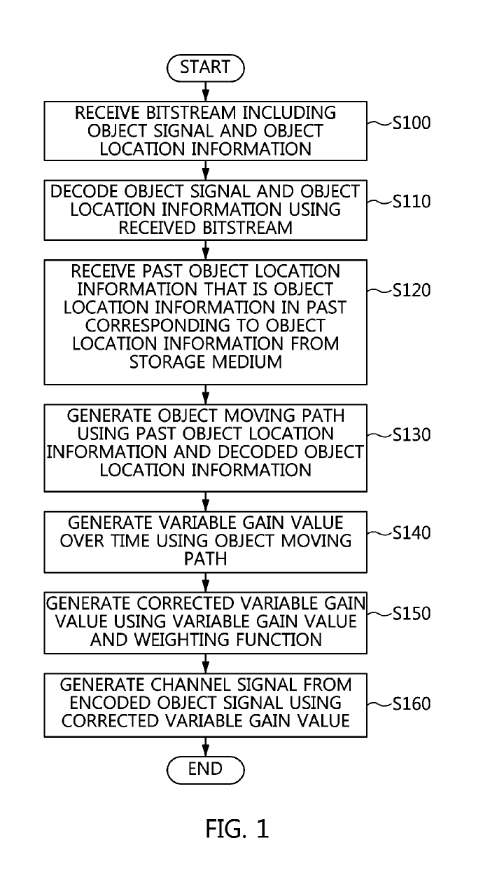

FIG. 1 is a flowchart showing an audio signal processing method for sound image localization according to the present invention.

Referring to FIG. 1, the audio signal processing method for sound image localization according to the present invention includes, in the audio signal processing method, the step S100 of receiving a bitstream including the object signal of audio and object position information of the audio, the step S110 of decoding the object signal and the object position information using the received bitstream, the step S120 of receiving past object position information, which is object position information in the past corresponding to the object position information, from a storage medium, the step S130 of generating an object moving path using the received past object position information and the decoded object position information, the step S140 of generating a variable gain value over time using the generated object moving path, the step S150 of generating a corrected variable gain value using the generated variable gain value and a weighting function, and the step S160 of generating a channel signal from the decoded object signal using the corrected variable gain value.

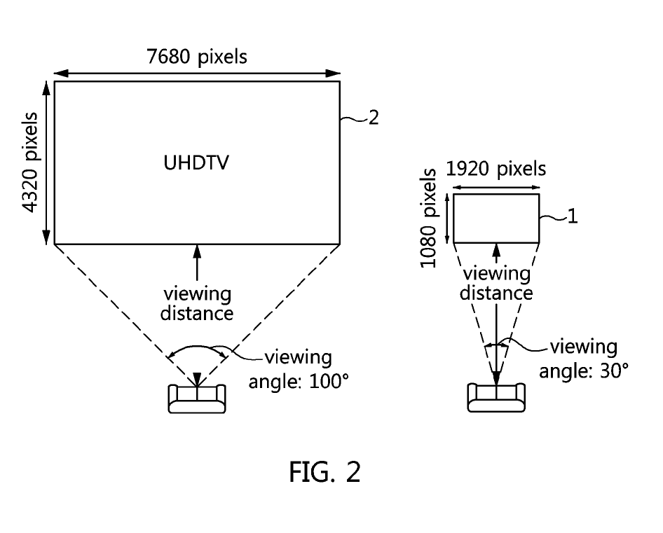

FIG. 2 is a diagram showing viewing angles depending on the sizes (e.g. ultra-high definition TV (UHDTV) and high definition TV (HDTV)) of an image at the same viewing distance. With the development of production technology of displays and an increase in consumer demands, the size of an image is on an increasing trend. As shown in FIG. 2, a UHDTV (7680*4320 pixel image) 2 displays an image that is about 16 times larger than that of an HDTV (1920*1080 pixel image) 1. When the HDTV 1 is installed on the wall surface of a living room and a viewer is sitting on a sofa at a predetermined viewing distance, the viewing angle may be 30°. However, when the UHDTV 2 is installed at the same viewing distance, the viewing angle reaches about 100°.

In this way, when a high-quality and high-resolution large screen is installed, it is preferable to provide sound with high presence and immersive surround sound envelopment in conformity with large-scale content. To provide such an environment, in which a viewer feels as if he or she were present in a scene, it may be insufficient to provide only 12 surround channel speakers. Therefore, a multichannel audio environment having a larger number of speakers and channels may be required.

As described above, in addition to a home theater environment, a personal 3D TV, a smart phone TV, a 22.2 channel audio program, a vehicle, a 3D video, a telepresence room, cloud-based gaming, etc. may be present.

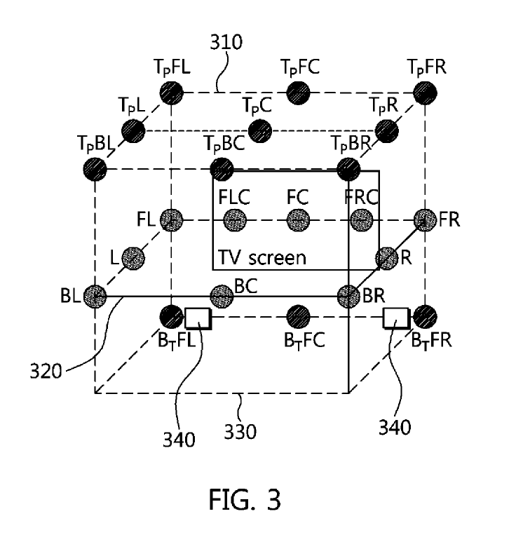

FIG. 3 is a configuration diagram showing an arrangement of 22.2 channel speakers as an example of a multichannel environment.

The 22.2 channels may be an example of a multichannel environment for improving sound field effects, and the present invention is not limited to the specific number of channels or the specific arrangement of speakers.

Referring to FIG. 3, 22.2 channel speakers are distributed to and arranged in three layers 310, 320, and 330. The three layers 310, 320, and 330 include a top layer 310 at the highest position of the three layers, a bottom layer 330 at the lowest position, and a middle layer 320 between the top layer 310 and the bottom layer 330.

In accordance with the embodiment of the present invention, in the top layer 310, a total of 9 channels, TpFL, TpFC, TpFR, TpL, TpC, TpR, TpBL, TpBC, and TpBR, may be provided. Referring to FIG. 3, it can be seen that, in the top layer 310, speakers are arranged in a total of 9 channels in such a way that speakers are arranged in 3 channels TpFL, TpFC, and TpFR in front positions in the direction from left to right, 3 channels TpL, TpC, and TpR in center positions in the direction from left to right, and 3 channels TpBL, TpBC, and TpBR in back positions in the direction from left to right. In the present specification, the front positions may mean a screen side.

In the embodiment of the present invention, in the middle layer 320, a total of 10 channels FL, FLC, FC, FRC, FR, L, R, BL, BC, and BL may be provided. Referring to FIG. 3, in the middle layer 320, speakers may be arranged in 5 channels FL, FLC, FC, FRC, and FR in front positions in the direction from left to right, 2 channels L and R, in center positions in the direction from left to right, and 3 channels BL, BC, and BL in back positions in the direction from left to right. Among the 5 speakers in the front positions, three speakers at the center may be included in a TV screen.

In accordance with the embodiment of the present invention, in the bottom layer 330, a total of 3 channels BtFL, BtFC, and BtFR, and two LFE channels 340 may be provided. Referring to FIG. 3, speakers may be arranged in the respective channels of the bottom layer 330.

Upon transmitting and reproducing a multichannel signal ranging to a maximum of several tens of channels, beyond the 22.2 channels exemplified above, a high computational load may be required. Further, in consideration of the communication environment or the like, high compressibility may be required.

In addition, in typical homes, a multichannel (e.g. 22.2 ch) speaker environment is not frequently provided, and many listeners have 2 ch or 5.1 ch setups. Thus, in the case where signals to be transmitted in common to all users are sent after having been respectively encoded into a multichannel signal, the multichannel signal must be converted back into 2 ch and 5.1 ch signals and be reproduced, thus resulting in communication inefficiency. In addition, since 22.2 ch Pulse Code Modulation (PCM) signals must be stored, memory management may be inefficiently performed.

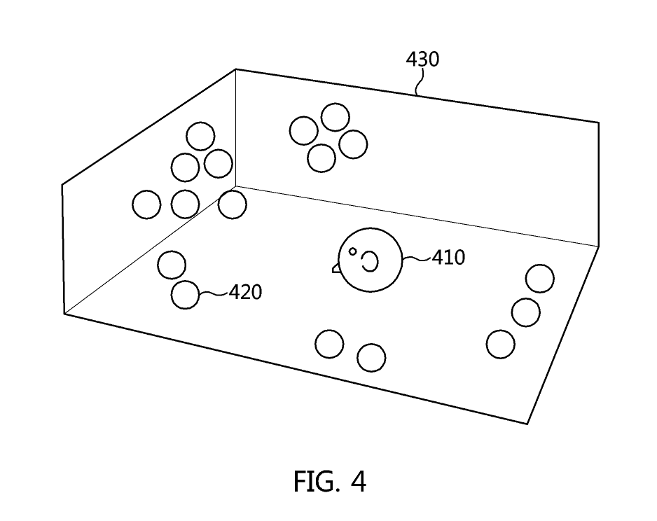

FIG. 4 is a conceptual diagram showing the positions of respective sound objects 420 constituting a 3D sound scene in a listening space 430 in which a listener 410 listens to 3D audio. Referring to FIG. 4, for the convenience of illustration, respective sound objects 420 are shown as point sources, but may be plane wave-type sound sources or ambient sound sources (reverberant sounds spreading in all directions to convey the space of a sound scene) in addition to point sources.

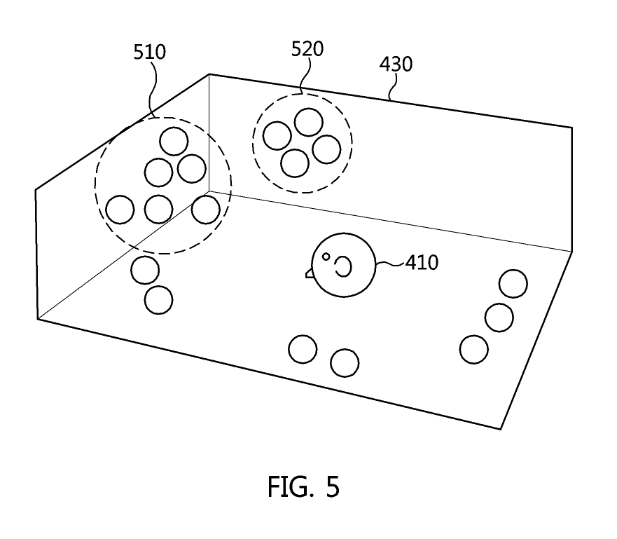

FIG. 5 illustrates the formation of object signal groups 510 and 520 for the objects illustrated in FIG. 4 using a grouping method according to the present invention. The present invention is characterized in that, upon coding or processing object signals, object signal groups are formed and coding or processing is performed on a grouped object basis. In this case, coding includes the case where each object is independently encoded (discrete coding) as a discrete signal, and the case of parametric coding performed on object signals. In particular, the present invention is characterized in that, upon generating downmix signals required for parametric coding of object signals and generating parameter information of objects corresponding to downmixing, the downmix signals and the parameter information are generated on a grouped object basis.

That is, in the case of Spatial Audio Object Coding (SAOC) coding technology as an example of conventional technology, all objects constituting a sound scene are represented by a single downmix signal (where a downmix signal may be mono (1 channel) or stereo (2 channel) signals, but is represented by a single downmix signal for convenience of description) and object parameter information corresponding to the downmix signal. However, using such a method, when 20 or more objects and a maximum of 200 or 500 objects are represented by a single downmix signal and a corresponding parameter, as in the case of scenarios taken into consideration in the present invention, it is actually impossible to perform upmixing and rendering such that a desired sound quality is provided. Accordingly, the present invention uses a method of grouping objects to be targets of coding and generating downmix signals on a group basis. During the procedure of performing downmixing on a group basis, downmix gains may be applied to the downmixing of respective objects, and the applied downmix gains for respective objects are included as additional information in the bitstreams of the respective groups.

Meanwhile, a global gain applied in common to groups and object group gains limitedly applied only to objects in each group may be used so as to improve the efficiency of coding or effectively control all gains. These gains are encoded and included in bitstreams and are transmitted to a receiving stage.

A first method of forming groups is a method of forming closer objects as a group in consideration of the positions of respective objects in a sound scene. The object groups 510 and 520 in FIG. 5 are examples of groups formed using such a method. This is a method for maximally preventing a listener 410 from hearing crosstalk distortion occurring between objects due to the incompleteness of parametric coding or distortion occurring when objects are moved to a third position or when rendering related to a change in size is performed. There is a strong possibility that distortion occurring in objects placed at the same position will not be heard by the listener due to masking. For the same reason, even when performing discrete coding, the effect of sharing additional information may be predicted via the grouping of objects at spatially similar positions.

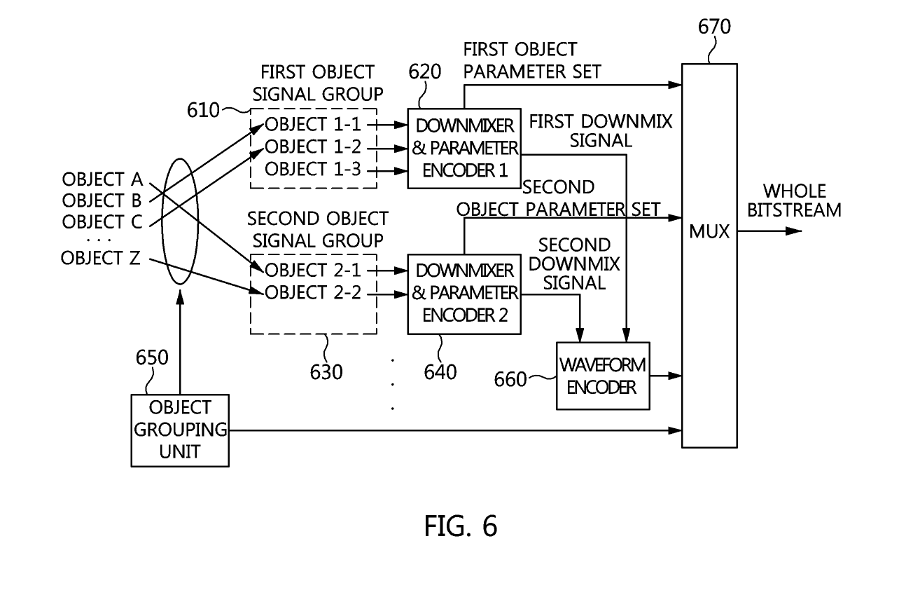

FIG. 6 is a block diagram showing an embodiment of an object audio signal encoder including an object grouping and downmixing method according to the present invention. Downmixing is performed for each group, and parameters required to restore downmixed objects in this procedure are generated (620, 640). The downmix signals generated for respective groups are additionally encoded by a waveform encoder 660 for coding channel-based waveforms such as AAC and MP3. This is commonly called a core codec. Further, encoding may be performed via coupling or the like between respective downmix signals. The signals generated by the respective encoders are formed as a single bitstream and transmitted through a multiplexer (MUX) 670. Therefore, the bitstreams generated by downmixer & parameter encoders 620 and 640 and the waveform encoder 660 may be regarded as those of the case where component objects forming a single sound scene are encoded.

Further, object signals belonging to different object groups in a generated bitstream are encoded in the same time frame, and thus they may have the characteristic of being reproduced in the same time slot. Meanwhile, the grouping information generated by an object grouping unit may be encoded and transferred to a receiving stage.

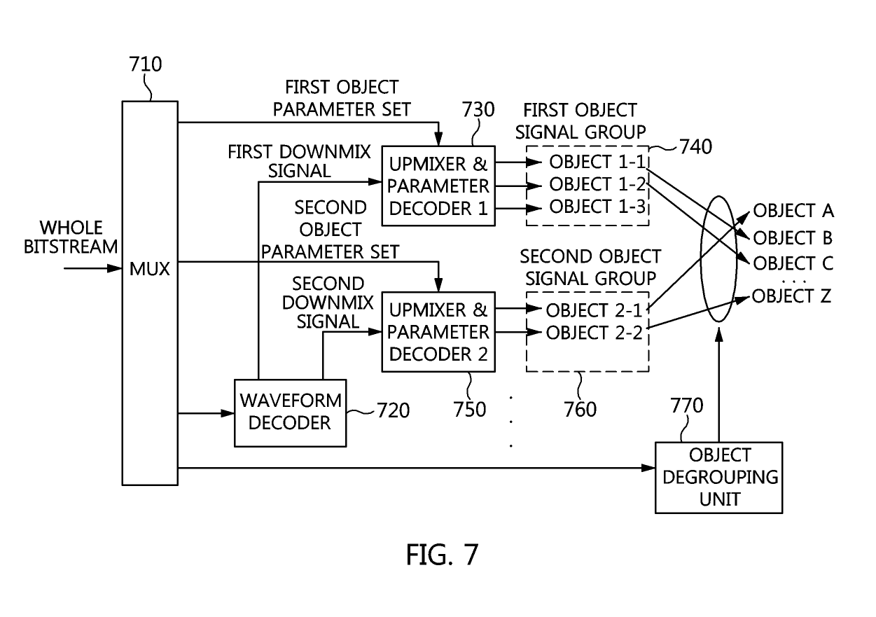

FIG. 7 is a block diagram showing an example of decoding of a signal encoded and transmitted using the above procedure. The decoding procedure is the reverse of the encoding procedure, wherein a plurality of downmix signals that are waveform-encoded (720) are input to up-mixer & parameter decoders, together with the corresponding parameters. Since a plurality of downmixers is present, the decoding of a plurality of parameters is required.

When a global gain and object group gains are included in the transmitted bitstream, the magnitudes of normal object signals may be restored using the gains. Meanwhile, those gain values may be controlled in a rendering or transcoding procedure. The magnitudes of all signals may be adjusted via the adjustment of the global gain, and gains for respective groups may be adjusted via the adjustment of the object group gains.

For example, when object grouping is performed on a playback speaker basis, rendering may be easily implemented via the adjustment of object group gains upon adjusting the gains to implement flexible rendering, which will be described later.

In this case, although a plurality of parameter encoders or decoders is shown as being processed in parallel for the convenience of description, it is also possible to sequentially perform encoding or decoding on a plurality of object groups via a single system.

Another method of forming object groups is a method of grouping objects having low correlations therebetween into a single group. This method is performed in consideration of the phenomenon that it is difficult to individually separate objects having high correlations therebetween from downmix signals due to the features of parametric coding. In this case, it is also possible to perform a coding method that decreases the correlations between grouped individual objects by adjusting parameters such as downmix gains upon downmixing. The parameters used in this case are preferably transmitted so that they can be used to restore signals upon decoding.

A further method of forming object groups is a method of grouping objects having high correlation into a single group. This method is intended to improve compression efficiency in an application the availability of which is not high, although it is difficult using parameters to separate objects having high correlations therebetween. Since, in a core codec, a complex signal having various spectrums requires more bits in proportion to the complex signal, coding efficiency is high if objects having high correlations therebetween are grouped to utilize a single core codec.

Yet another method of forming object groups is to perform coding by determining whether masking has been performed between objects. For example, when object A has the relationship of masking object B, if the two corresponding signals are included in a downmix signal and encoded using a core codec, object B may be omitted in a coding procedure. In this case, when the object B is obtained using parameters in a decoding stage, distortion is increased.

Therefore, objects A and B having such a relationship therebetween are preferably included in separate downmix signals. In contrast, in the case of an application in which object A and object B have a masking relationship, but there is no need to separately render the two objects, or in the case where additional processing is not required for at least a masked object, the objects A and B are preferably included in a single downmix signal. Therefore, the selection method may differ according to the application.

For example, when a specific object is masked and deleted or is at least weak in a preferable sound scene in an encoding procedure, an object group may be implemented by excluding the deleted or weak object from an object list and including it in an object that will be a masker, or by combing two objects and representing them by a single object.

Still another method of forming an object group is a method of separating objects such as plane wave source objects or ambient source objects, other than point source objects, and grouping the separated objects.

Due to characteristics differing from those of the point sources, the sources require another type of compression encoding method or parameters, and thus it is preferable to separate and process the sources.

Pieces of object information decoded for each group are reconstructed into original objects via object degrouping by referring to the transmitted grouping information.

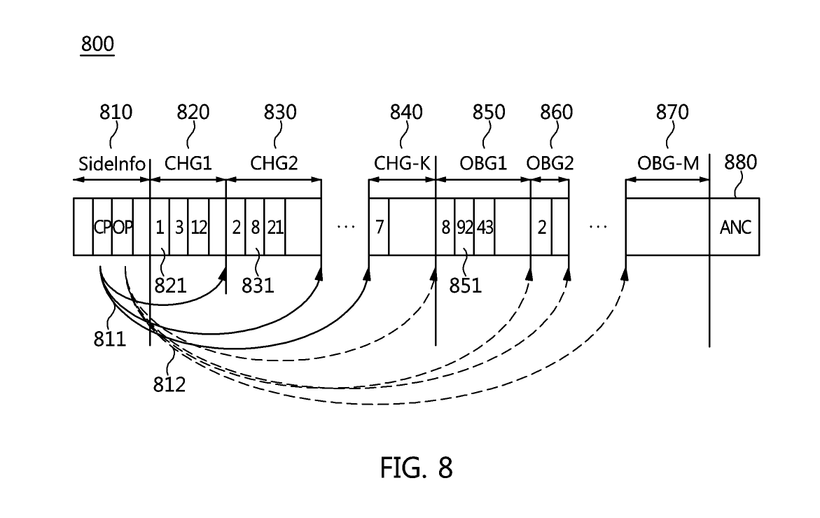

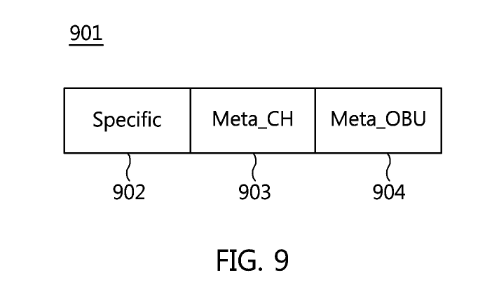

FIGS. 8 and 9 are diagrams showing examples of a bitstream generated by performing encoding according to the encoding method of the present invention. Referring to FIG. 8, it can be seen that a main bitstream 800, by which encoded channel or object data is transmitted, is aligned in the sequence of channel groups 820, 830, and 840 or in the sequence of object groups 850, 860, and 870. Further, since a header 810 includes channel group position information CHG_POS_INFO 811 and object group position information OBJ_POS_INFO 812, which correspond to pieces of position information of respective groups in the bitstream, only data of a desired group may be primarily decoded, without sequentially decoding the bitstream.

Therefore, the decoder primarily decodes data that has arrived first on a group basis, but the sequence of decoding may be randomly changed due to another policy or for some other reason.

Further, FIG. 9 illustrates a sub-bitstream 901 containing metadata 903 and 904 for each channel or each object, together with principal decoding-related information, in addition to the main bitstream 800. The sub-bitstream may be intermittently transmitted while the main bitstream is transmitted, or may be transmitted through a separate transmission channel.

(Method of Allocating Bits to Each Object Group)

Upon generating downmix signals for respective groups and performing independent parametric object coding for respective groups, the number of bits used in each group may differ from that of other groups. For criteria for allocating bits to respective groups, the number of objects contained in each group, the number of effective objects in consideration of the masking effect between objects in the group, weights depending on positions in consideration of the spatial resolution of a person, the intensities of sound pressures of objects, correlations between objects, the levels of importance of objects in a sound scene, etc. may be taken into consideration. For example, when three spatial object groups A, B, and C are present, and they have three object signals, two object signals, and one object signal, respectively, bits allocated to the respective groups may be defined as 3a1(nx), 2 2a2(ny), and a3n, where x and y denote the extents to which the number of bits to be allocated may be reduced due to the masking effect between the objects in each group and the masking effect in each object, and a1, a2, and a3 may be determined by the various above-described factors for each group.

(Encoding of Position Information of Main Object and Sub-Object in Object Group)

Meanwhile, in the case of object information, it is preferable to have a means for transferring mix information or the like, recommended according to the intention of a producer or proposed by another user, as the position and size information of the corresponding object through metadata. In the present invention, such a means is called preset information for the sake of convenience. In the case of preset position information, especially a dynamic object, the position of which varies over time, the amount of information to be transmitted is not small. For example, if it is assumed that, for 1000 objects, the position information thereof varying in each frame is transmitted, a very large amount of data is obtained. Therefore, it is preferable to efficiently transmit even the position information of objects.

Accordingly, the present invention uses a method of effectively encoding position information using the definition of a ‘main object’ and a ‘sub-object’.

A main object is an object, the position information of which is represented by absolute coordinate values in a 3D space. A sub-object is an object, the position of which, in a 3D space, is represented by values relative to the main object, thus having position information. Therefore, a sub-object must perceive which main object it corresponds to. However, when grouping is performed, in particular, when grouping is performed based on spatial positions, grouping may be implemented using a method of representing position information by designating a single object as a main object and remaining objects as sub-objects in the same group. When grouping for encoding is not performed, or when the use of grouping is not favorable to the encoding of the position information of sub-objects, a separate set for position information encoding may be formed. In order to cause the relative representation of position information of sub-objects to be more profitable than the representation thereof using absolute values, it is preferable that objects belonging to a group or a set be located within a predetermined range in space.

Another position information encoding method according to the present invention is to represent the position information as information relative to the position of a fixed speaker instead of the representation of positions relative to a main object. For example, the relative position information of each object is represented with respect to the designated positions of 22 channel speakers. Here, the number and position values of speakers to be used as a reference may be determined based on the values set in current content.

In accordance with another embodiment of the present invention, after position information is represented by an absolute value or a relative value, quantization must be performed, wherein a quantization step is characterized by being variable with respect to an absolute position. For example, it is known that a listener has much higher position identification ability in front of him or her than behind or to the side, and thus it is preferable to set a quantization step so that the resolution of a front position is higher than that of a side position. Similarly, since a person has higher resolution in lateral orientation than resolution in height, it is preferable to set a quantization step so that the resolution of azimuth angles is higher than that of elevation angles.

In a further embodiment of the present invention, in the case of a dynamic object, the position of which is time-varying, it is possible to represent the position information of the dynamic object using a value relative to its previous position value, instead of representing the position relative to a main object or another reference point. Therefore, for the position information of a dynamic object, flag information required to determine which one of a previous point in a temporal aspect and a neighboring reference point in a spatial aspect has been used as a reference may be transmitted together with the position information.

(Overall Architecture of Decoder)

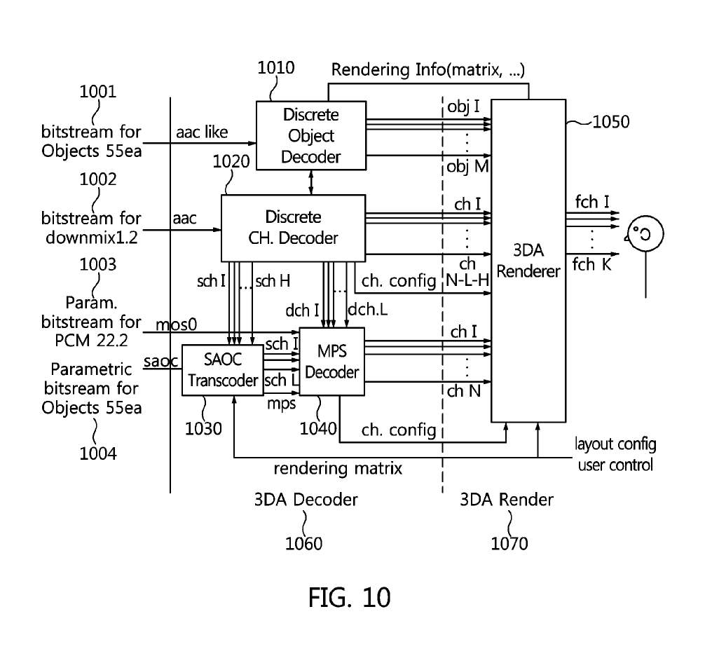

FIG. 10 is a block diagram showing an embodiment of an object and channel signal decoding system according to the present invention.

The system may receive an object signal 1001 or a channel signal 1002, or a combination of the object signal and the channel signal. The object signal or the channel signal may be individually waveform-coded (1001, 1002) or parametrically coded (1003, 1004).

The decoding system may be chiefly divided into a 3D Architecture (3DA) decoder 1060 and a 3DA renderer 1070, wherein the 3DA renderer 1070 may be implemented using any external system or solution. Therefore, the 3DA decoder 1060 and the 3DA renderer 1070 preferably provide a standardized interface that is easily compatible with external systems.

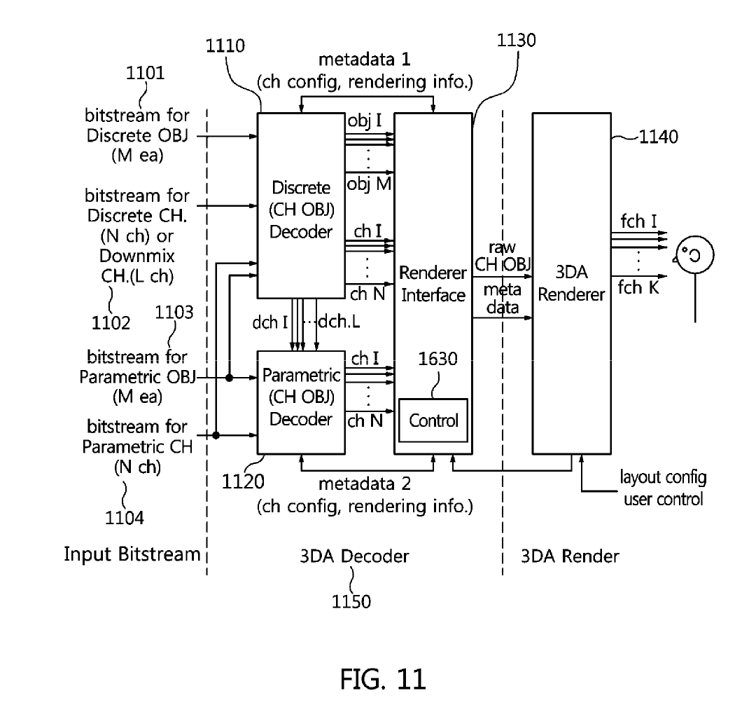

FIG. 11 is a block diagram showing another embodiment of an object and channel signal decoding system according to the present invention. Similarly, the present system may receive an object signal 1101 or a channel signal 1102, or a combination of the object signal and the channel signal. Further, the object signal or the channel signal may be individually waveform-coded (1101, 1102) or parametrically-coded (1103, 1104).

Compared to the system of FIG. 10, the decoding system of FIG. 11 has a difference in that a discrete object decoder 1010 and a discrete channel decoder 1020, which are separately provided, and a parametric channel decoder 1040 and a parametric object decoder 1030, which are separately provided, are respectively integrated into a single discrete decoder 1110 and into a single parametric decoder 1120, and in that a 3DA renderer 1140 and a renderer interface 1130 for convenient and standardized interfacing are additionally provided. The renderer interface 1130 functions to receive user environment information, renderer version, etc. from the 3DA renderer 1140, present either inside or outside of the system, and transfer metadata required to reproduce the received information and display related information, together with a type of channel signal or object signal compatible with the received information. The 3DA renderer interface 1130 may include a sequence control unit 1830, which will be described later.

The parametric decoder 1120 requires a downmix signal to generate an object signal or a channel signal, and this required downmix signal is decoded by and input from the discrete decoder 1110. The encoder corresponding to the object and channel signal decoding system may be any of various types of encoders, and any type of encoder may be regarded as a compatible encoder as long as it may generate at least one of types of bitstreams 1001, 1002, 1003, 1004, 1101, 1102, 1103, and 1104, illustrated in FIGS. 10 and 11. Further, according to the present invention, the decoding systems presented in FIGS. 10 and 11 are designed to guarantee compatibility with past systems or bitstreams.

For example, when a discrete channel bitstream encoded using Advanced Audio Coding (AAC) is input, the corresponding bitstream may be decoded by a discrete (channel) decoder, and may be transmitted to the 3DA renderer. An MPEG Surround (MPS) bitstream is transmitted together with a downmix signal. A signal that has been encoded using AAC after being downmixed is decoded by a discrete (channel) decoder and is transferred to the parametric channel decoder, and the parametric channel decoder operates like an MPEG surround decoder. A bitstream that has been encoded using Spatial Audio Object Coding (SAOC) is processed in the same manner. In the case of SAOC, the system of FIG. 10 has a structure in which SAOC functions as a transcoder, as in the case of a conventional scheme, and then the transcoded signal is rendered to a channel through the MPEG surround decoder. For this, the SAOC transcoder preferably receives reproduction channel environment information, generates an optimized channel signal suitable for such environment information, and transmits the optimized channel signal. Therefore, it is possible to receive and decode a conventional SAOC bitstream, and rendering specialized for a user or a reproduction environment may be performed. When an SAOC bitstream is input, the system of FIG. 11 performs decoding using a method of directly converting the SAOC bitstream into a channel or a discrete object suitable for rendering instead of a transcoding operation for converting the SAOC bitstream into an MPS bitstream.

Therefore, the system has a lower computational load than that of a transcoding structure, and is also advantageous in terms of sound quality. In FIG. 11, the output of the object decoder is indicated only by “channels”, but may also be transferred to the renderer interface as discrete object signals. Further, although shown only in FIG. 11, in the case where a residual signal is included in a parametric bitstream, including the case of FIG. 10, there is a characteristic in that the decoding of the residual signal is performed by a discrete decoder.

(Discrete, Parameter Combination, and Residual for Channels)

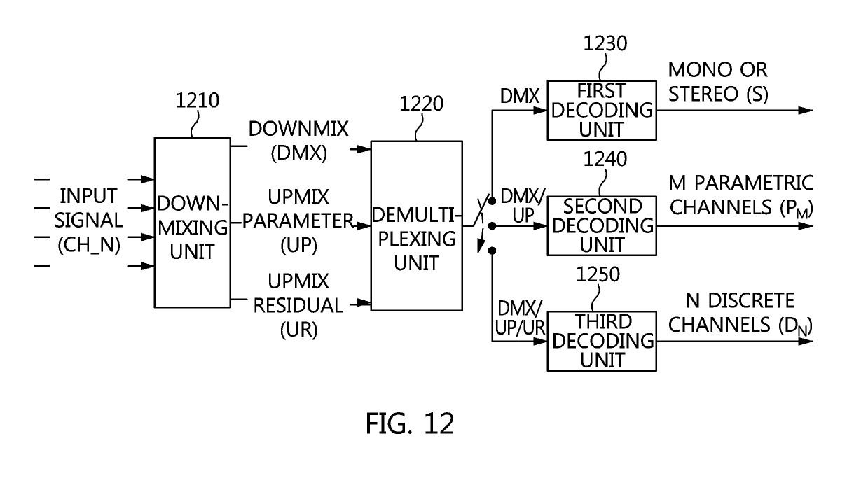

FIG. 12 is a diagram showing the configuration of an encoder and a decoder according to another embodiment of the present invention.

More specifically, FIG. 12 is a diagram showing a structure for scalable coding when a speaker setup of the decoder is differently implemented.

An encoder includes a downmixing unit 1210, and a decoder includes a demultiplexing unit 220 and one or more of first to third decoding units 1230 to 1250.

The downmixing unit 1210 downmixes input signals CH_N, corresponding to multiple channels, to generate a downmix signal DMX. In this procedure, one or more of an upmix parameter UP and an upmix residual UR are generated. Then, the downmix signal DMX and the upmix parameter UP (and the upmix residual UR) are multiplexed, and thus one or more bit streams are generated and transmitted to the decoder. Here, the upmix parameter UP, which is a parameter required in order to upmix one or more channels into two or more channels, may include a spatial parameter, an inter-channel phase difference (IPD), etc.

Further, the upmix residual UR corresponds to a residual signal corresponding to the difference between the input signal CH_N, which is an original signal, and a restored signal. Here, the restored signal may be either an upmixed signal obtained by applying the upmix parameter UP to the downmix signal DMX or a signal obtained by encoding a channel signal, which is not downmixed by the downmixing unit 1210, in a discrete manner. The demultiplexing unit 1220 of the decoder may extract the downmix signal DMX and the upmix parameter UP from one or more bitstreams, and may further extract an upmix residual UR. Here, the residual signal may be encoded using a method similar to a method of discretely coding a downmix signal. Therefore, the decoding of the residual signal is characterized by being performed via the discrete (channel) decoder in the system presented in FIG. 8 or 9.

The decoder may selectively include one (or one or more) of the first decoding unit 1230 to the third decoding unit 1250 according to the speaker setup environment of the decoder. The setup environment of a loudspeaker may vary depending on the type of device (smart phone, stereo TV, 5.1ch home theater, 22.2ch home theater, etc.). In spite of the variety of environments, unless bitstreams and decoders for generating a multichannel signal such as 22.2ch signals are selective, all 22.2ch signals are restored and must then be downmixed depending on the speaker playback environment. This may result not only in a high computational load, required for restoration and downmixing, but also in a delay.

However, in accordance with another embodiment of the present invention, one (or more) of the first to third decoders is selectively provided depending on the setup environment of each device, thus solving the above-described disadvantage.

The first decoder 230 is a component for decoding only a downmix signal DMX, and is not accompanied by an increase in the number of channels. That is, the first decoder outputs a mono-channel signal when a downmix signal is a mono signal, and outputs a stereo signal when the downmix signal is a stereo signal. The first decoder may be suitable for a headphone-equipped device, a smart phone, or a TV, the number of speaker channels of which is one or two.

Meanwhile, the second decoder 1240 receives the downmix signal DMX and the upmix parameter UP, and generates a parametric M channel PM based on them. The second decoder increases the number of channels compared to the first decoder. However, when an upmix parameter UP includes only parameters corresponding to upmixing ranging to a total of M channels, the second decoder may reproduce M channel signals, the number of which is less than the number of original channels N. For example, when an original signal, which is the input signal of the encoder, is a 22.2ch signal, M channels may be 5.1ch, 7.1ch, etc.

The third decoder 1250 receives not only downmix signal DMX and the upmix parameter UP, but also the upmix residual UR. Unlike the second decoder, which generates M parametric channel signals, the third decoder additionally applies the upmix residual signal UR to the parametric channel signals, thus outputting restored signals of N channels.

Each device selectively includes one or more of first to third decoders, and selectively parses an upmix parameter UP and an upmix residual UR from the bitstreams, so that signals suitable for each speaker setup environment are immediately generated, thus reducing complexity and the computational load.

(Object Waveform Encoding in which Masking is Considered)

An object waveform encoder according to the present invention (hereinafter, a ‘waveform encoder’ denotes the case where a channel or object audio signal is encoded so that it is independently decoded for each channel or for each object, and ‘waveform coding/decoding’ is a concept relative to that of parametric coding/decoding, and is also called discrete coding/decoding) allocates bits in consideration of the positions of objects in a sound scene.

This uses a psychoacoustic Binaural Masking Level Difference (BMLD) phenomenon and the features of object signal encoding.

In order to describe the BMLD phenomenon, an example of mid-side (MS) stereo coding, used in an existing audio coding method, is employed for description as follows. That is, BMLD is a psychoacoustic masking phenomenon in which masking is possible when a masker causing masking and a maskee to be masked are present in the same direction in a space. When the correlation between two channel audio signals of stereo audio signals is very high, and the magnitudes of the signals are identical to each other, an image (sound image) for the sounds is formed at the center of a space between two speakers. When there is no correlation therebetween, independent sounds are output from respective speakers and the sound images thereof are respectively formed on the speakers.

When respective channels are independently encoded (dual mono manner) for input signals having the maximum correlation, sound images of audio signals are formed at the center and sound images of quantization noises are separately formed on the respective speakers because quantization noises occurring on respective channels at that time are not mutually correlated with each other.

Therefore, quantization noises, intended to be the maskee, are not masked due to spatial mismatch, and thus a problem arises in that a person hears the corresponding noises as distortion. In order to solve this problem, mid-side stereo coding is intended to generate a mid (sum) signal obtained by summing two channel signals and a side (difference) signal obtained by subtracting the two channel signals from each other, perform psychoacoustic modeling using the mid signal and the side signal, and perform quantization using a resulting psychoacoustic model, thus enabling the generated quantization noises to be formed at the same position as that of sound images.

In conventional channel coding, respective channels are mapped to playback speakers, and the positions of the corresponding speakers are fixed and spaced apart from each other, and thus masking between the channels cannot be taken into consideration. However, when respective objects are independently encoded, whether masking has been performed may vary depending on the positions of the corresponding objects in a sound scene.

Therefore, it is preferable to determine whether an object currently being encoded has been masked by other objects, allocate bits depending on the results of determination, and then encode the object.

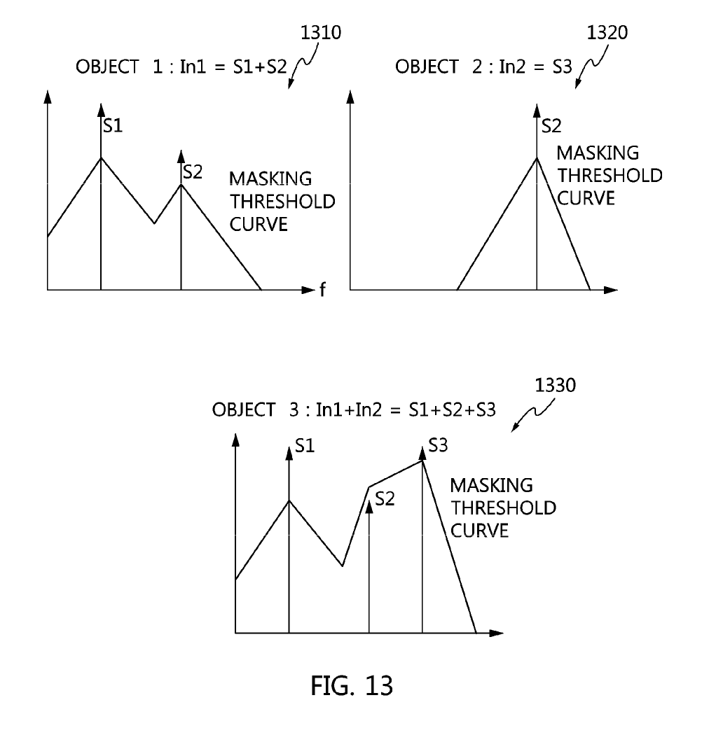

FIG. 13 illustrates respective signals for object 1 1310 and object 2 1320, masking thresholds that may be acquired from the respective signals, and a masking threshold 1330 for the sum signal of object 1 and object 2.

When object 1 and object 2 are regarded as being located at the same position with respect to the position of a listener, or located within a range in which the problem of BMLD does not occur, an area masked by the corresponding signals may be given as 1330 to the listener, so that signal S2 included in object 1 will be a signal that is completely masked and inaudible. Therefore, in a procedure for encoding object 1, the object 1 is preferably encoded in consideration of the masking threshold of the object 2. Since the masking thresholds have the property of additively summing each other, the masking thresholds may be obtained using a method of adding the respective masking thresholds for the object 1 and the object 2.

Alternatively, since a procedure itself for calculating masking thresholds has a very high computational load, it is preferable to calculate a single masking threshold using a signal generated by previously summing the object 1 and the object 2, and to individually encode the object 1 and the object 2.

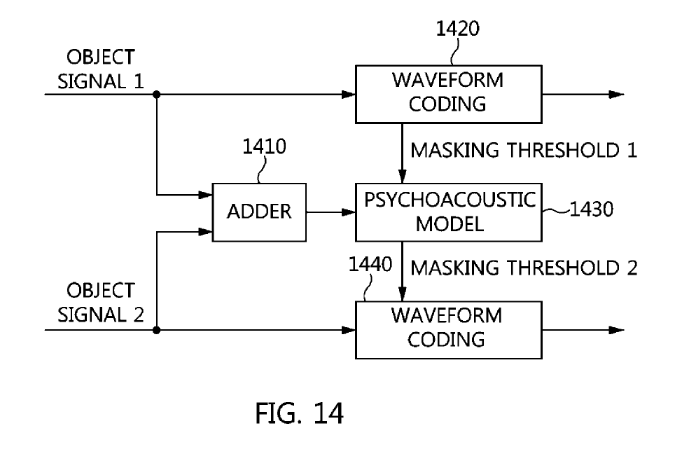

FIG. 14 illustrates an embodiment of an encoder for calculating masking thresholds for a plurality of object signals according to the present invention.

Another method of calculating masking thresholds according to the present invention is configured such that, when the positions of two objects are not completely identical to each other based on auditory sensing, masking levels may also be attenuated and reflected in consideration of the degree to which two objects are spaced apart from each other in a space, instead of summing masking thresholds for two objects. That is, when a masking threshold for object 1 is M1(f) and a masking threshold for object 2 is M2(f), final joint masking thresholds M1′(f) and M2′(f), to be used to encode individual objects, are generated so as to have the following relationship.

M1′(f)=M1(f)+A(f)M2(f)

M2′(f)=A(f)M1(f)+M2(f) [Equation 1]

where A(f) is an attenuation factor generated using the spatial position and distance between two objects, the attributes of two objects, etc., and has a range of 0.0=<A(f)=<1.0.

The resolution of human orientation has the characteristics of decreasing in the direction from a front side to left and right sides, and of further decreasing in a direction to a rear side. Therefore, the absolute positions of the objects may act as other factors for determining A(f).

In another embodiment of the present invention, the threshold calculation method may be implemented using a method in which one of two objects uses its own masking threshold and only the other object fetches the masking threshold of the counterpart object. Such objects are called an independent object and a dependent object, respectively. Since an object that uses only its own masking threshold is encoded at high sound quality regardless of the counterpart object, there is the advantage of the sound quality being maintained even if rendering causing an object to be spatially separated from the corresponding object is performed. When the object 1 is an independent object and the object 2 is a dependent object, masking thresholds may be represented by the following equation:

M1′(f)=M1(f)

M2′(f)=A(f)M1(f)+M2(f) [Equation 2]

Information about whether a given object is an independent object or a dependent object is preferably transferred to a decoder and a renderer as additional information about the corresponding object.

In a further embodiment of the present invention, when two objects are similar to each other to some degree in a space, it is possible to combine signals themselves into a single object signal and process the single object signal without summing only masking thresholds and generating joint masking thresholds.

In yet another embodiment of the present invention, when parametric coding, in particular, is performed, it is preferable to combine and process the two objects into a single object in consideration of the correlation between two signals and the spatial positions of the two signals.

(Transcoding Features)

In yet another embodiment of the present invention, to perform transcoding, especially at a lower bit rate when transcoding a bitstream including coupled objects, it is preferable to represent the coupled objects by a single object when the number of objects must be reduced so as to reduce the size of data, that is, when a plurality of objects is downmixed and represented by a single object.

Upon describing the above coding based on coupling between objects, the case where only two objects are coupled to each other has been exemplified for convenience of description, but the coupling of two or more objects may be implemented in a similar manner.

(Requirement of Flexible Rendering)

Among the technologies required for 3D audio, flexible rendering is one of the important issues to be solved in order to maximize the quality of 3D audio. It is well known that the positions of 5.1 channel speakers are very atypical depending on the structure of a living room and the arrangement of pieces of furniture. The sound scene intended by a content creator must be able to be provided even when speakers are placed at such atypical positions. For this, rendering technology for correcting the differences relative to positions based on standards is required together with the cognition of speaker environments in reproduction environments, which differ for respective users. That is, the function of a codec is not merely the decoding of transmitted bitstreams according to the decoding method, and a series of technologies for a procedure for optimizing and transforming the decoded bitstreams in conformity with the user's reproduction environment are required.

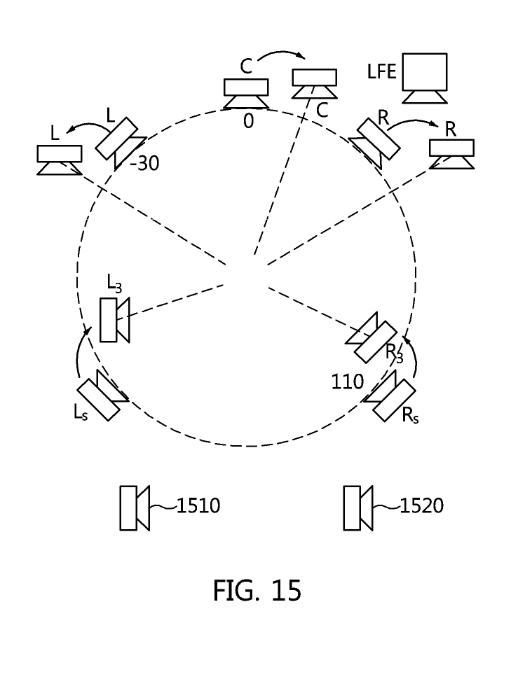

FIG. 15 illustrates an arrangement 1310 according to ITUR recommendations and an arrangement 1320 at random positions for a 5.1 channel setup. A problem may arise in that, in the environment of an actual living room, the azimuth angles and distances of speakers are changed compared to ITUR recommendations (although not shown in the drawing, the heights of the speakers may also differ).

When original channel signals are reproduced without change at the changed positions of speakers in this way, it is difficult to provide an ideal 3D sound scene.

(Flexible Rendering)

When amplitude panning, for determining the orientation information of sound sources between two speakers based on the magnitudes of signals, or Vector-Based Amplitude Panning (VBAP), which is widely used to determine the orientation of sound sources using three speakers in a 3D space is used, it can be seen that flexible rendering may be relatively conveniently implemented for object signals transmitted for respective objects. This is one of the advantages of transmitting object signals instead of channel signals.

(Object Decoding and Rendering Structure)

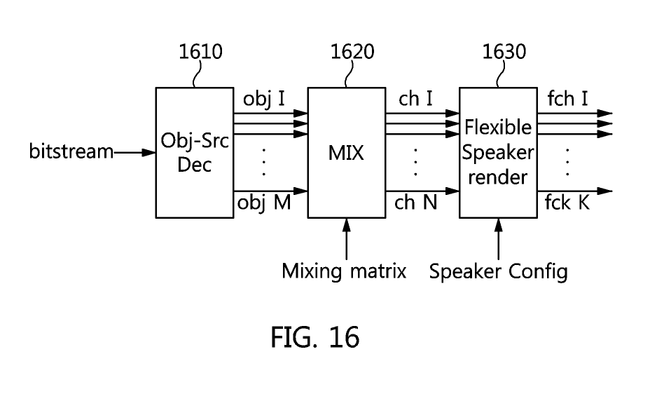

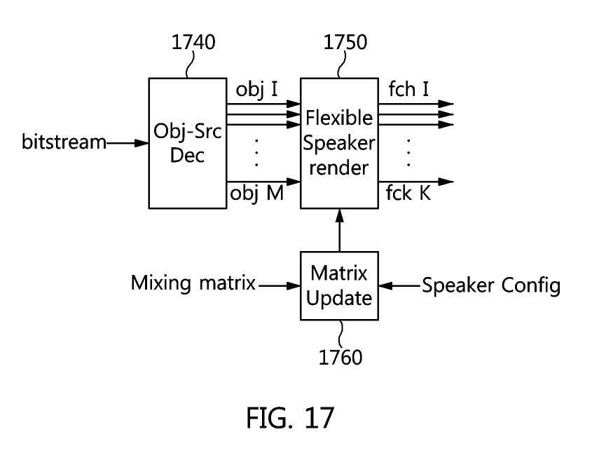

FIGS. 16 and 17 illustrate the structures of two embodiments in which a decoder for an object bitstream and a flexible rendering system using the decoder are connected according to the present invention. As described above, such a structure is advantageous in that objects may be easily located as sound sources in conformity with a desired sound scene. Here, a mix unit 1620 receives position information represented by a mixing matrix and first changes the position information to channel signals. That is, the position information for the sound scene is represented by relative information from speakers corresponding to output channels. In this case, when the number of actual speakers and the positions of the speakers do not correspond to a designated number and designated positions, a procedure for re-rendering the channel signals using given position information Speaker Config is required. As will be described later, re-rendering of channel signals into other types of channel signals is more difficult to implement than direct rendering of objects to final channels.

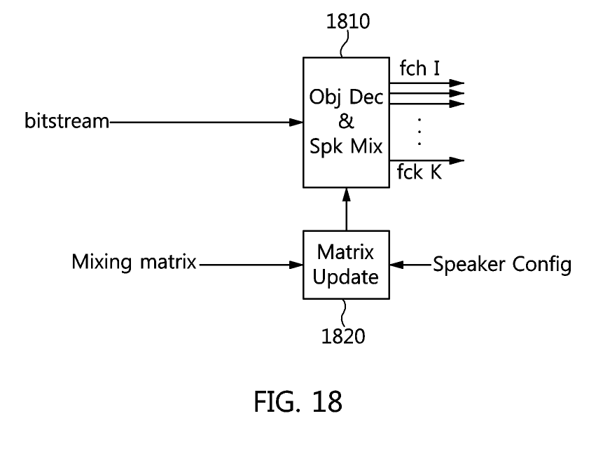

FIG. 18 illustrates the structure of another embodiment in which decoding and rendering of an object bitstream are implemented according to the present invention. Compared to the case of FIG. 16, flexible rendering 1810 suitable for a final speaker environment, together with decoding, is directly implemented from the bitstream. That is, instead of two stages including mixing performed in regular channels based on a mixing matrix and rendering to flexible speakers from regular channels generated in this way, a single rendering matrix or a rendering parameter is generated using a mixing matrix and speaker position information 1820, and object signals are immediately rendered to target speakers using the rendering matrix or the rendering parameter.

(Flexible Rendering Combined with Channel)

Meanwhile, when channel signals are transmitted as input, and the positions of speakers corresponding to the channels are changed to random positions, it is difficult to implement rendering using a panning technique such as that in objects, and a separate channel mapping process is required. A bigger problem is that, since the procedure required for rendering and the solution method are different from each other between object signals and channel signals in this way, distortion may easily occur due to spatial mismatch when object signals and channel signals are simultaneously transmitted and a sound scene in which two types of signals are mixed is desired to be created.

To solve this problem, another embodiment according to the present invention is configured to primarily perform mixing on channel signals and secondarily perform flexible rendering on the channel signals without separately performing flexible rendering on the objects. Rendering or the like using a Head Related Transfer Function (HRTF) is preferably implemented in a similar manner.

(Downmixing in Decoding Stage: Parameter Transmission or Automatic Generation)

When multichannel content is reproduced through fewer output channels than the number of channels of the multichannel content in downmix rendering, it is general that such reproduction has been implemented to date using an MN downmix matrix (where M is the number of input channels and N is the number of output channels).

That is, when 5.1 channel content is reproduced in a stereo manner, reproduction is implemented in such a way as to perform downmixing using a given formula. However, such a downmixing method has a problem with a computational load in that, although the playback speaker environment of a user is only a 5.1 channel environment, all bitstreams corresponding to 22.2 transmitted channels must be decoded. If all of 22.2 channel signals must be decoded even to generate stereo signals to be played on a portable device, the burden of computation is very high, and a large amount of memory is wasted (for the storage of decoded signals for 22.2 channels).

(Transcoding as Alternative to Downmixing)

As an alternative thereto, a method of converting significant original bitstreams corresponding to 22.2 channels into a number of bitstreams suitable for a target device or a target playback environment via effective transcoding may be considered. For example, for 22.2 channel content stored in a cloud server, a scenario for receiving reproduction environment information from a client terminal, converting the content in conformity with the reproduction environment information, and transmitting the converted information may be implemented.

(Decoding Sequence or Downmixing Sequence; Sequence Control Unit)

Meanwhile, in the case of a scenario in which a decoder and a renderer are separated, there may occur the case where 50 object signals, together with 22.2 channel audio signals, must be decoded and transferred to the renderer. In this case, the transmitted audio signals are signals which have been decoded and which have a high data rate, and thus a problem arises in that a very wide bandwidth is required between the decoder and the renderer. However, it is not preferable to simultaneously transmit a large amount of data at once, and therefore it is preferable to make an effective transmission schedule. Further, the decoder preferably determines a decoding sequence according to the plan and transmits the data.

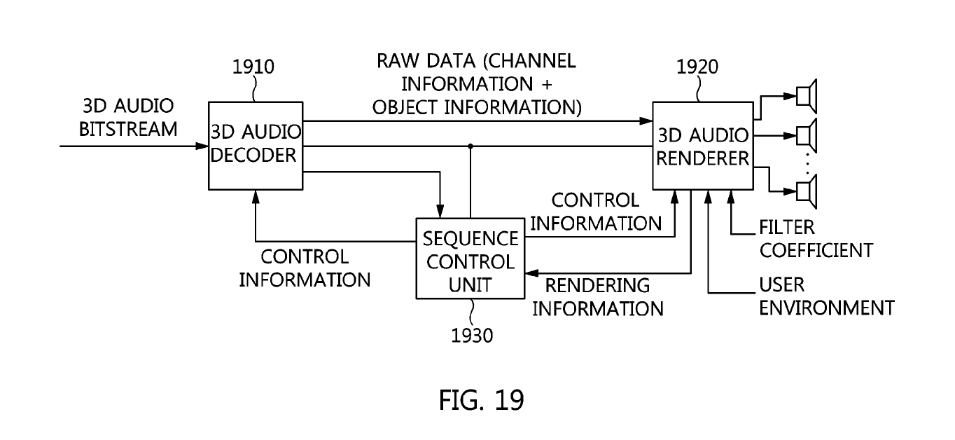

FIG. 19 is a block diagram showing a structure for determining a transmission schedule between the decoder and the renderer and performing transmission.

A sequence control unit 1930 functions to receive additional information, acquired by decoding bitstreams, metadata, and reproduction environment information, rendering information, etc. acquired from a renderer 1920, determine control information such as a decoding sequence and the transmission sequence and unit in which decoded signals are to be transmitted to the renderer 1920, and return the determined control information to a decoder 1910 and the renderer 1920. For example, when the renderer 1920 commands that a specific object should be completely deleted, the specific object needs to be neither transmitted to the renderer 1920 nor decoded.

Alternatively, as another embodiment, when specific objects are intended to be rendered only to a specific channel, a transmission band may be reduced if the corresponding objects have been downmixed in advance into the specific channel and transmitted, instead of separately transmitting the corresponding objects. As a further embodiment, when a sound scene is spatially grouped, and signals required for rendering are transmitted together for each group, the number of signals to be unnecessarily waited for in the internal buffer of the renderer may be minimized.

Meanwhile, the size of data that can be accepted at one time may differ depending on the renderer 1920. This information may also be reported to the sequence control unit 1930, so that the decoder 1910 may determine decoding timing and traffic in conformity with the reported information.

Meanwhile, the control of decoding by the sequence control unit 1930 may be transferred to an encoding stage, so that even an encoding procedure may be controlled. That is, it is possible to exclude unnecessary signals from encoding, or determine the grouping of objects or channels.

(Audio Superhighway)

Meanwhile, in bitstreams, an object corresponding to bidirectional communication audio may be included. Bidirectional communication is very sensitive to time delays, unlike other types of content. Therefore, when object signals or channel signals corresponding to bidirectional communication are received, they must be primarily transmitted to the renderer. The object or channel signals corresponding to bidirectional communication may be represented by a separate flag or the like. Such a primary transmission object has presentation time characteristics independent of other object/channel signals in the same frame, unlike other types of objects/channels.

(AV Matching and Phantom Center)

One of the new problems appearing when a UHDTV, that is, an ultra-high definition TV, is considered, is the situation commonly referred to as ‘near field.’ This means that, considering the viewing distance in a typical user environment (living room), the distance from a playback speaker to a listener becomes shorter than the distance between respective speakers, and thus the respective speakers act as point sound sources, and that in a situation in which a center speaker is not present because the screen is wide and large, high-quality 3D audio service may be provided only when the spatial resolution of sound objects synchronized with a video is very high.

In a conventional viewing angle of about 30°, stereo speakers arranged at left and right sides are not in a near field situation, and a sound scene suitable for the movement of objects on the screen (for example, a vehicle moving from left to right) may be sufficiently provided. However, in a UHDTV environment, in which the viewing angle reaches 100°, additional vertical resolution for configuring the upper and lower portion of the screen, as well as left and right horizontal resolution, is required. For example, when two characters appear on the screen, an existing HDTV does not cause a large problem in the sense of reality even if the sounds of the two characters are heard as if they were spoken at the center of the screen. However, in the size of UHDTV, mismatch between the screen and sounds corresponding thereto may be recognized as a new type of distortion. As one solution to this, the form of a 22.2 channel speaker configuration may be presented. FIG. 3 illustrates an example of the arrangement of 22.2 channels. According to FIG. 3, a total of 11 speakers are arranged in the front positions, so that the horizontal and vertical spatial resolutions of the front positions are greatly improved. 5 speakers are arranged in the middle layer, in which 3 speakers were placed in the past.

Further, 3 speakers are added to each of a top layer and a bottom layer, so that the pitch of sounds may be sufficiently handled. When such an arrangement is used, spatial resolution at the front position is increased compared to a conventional scheme, and thus matching with video signals may be similarly improved. However, current TVs using display devices such as a Liquid Crystal Display (LCD) and an Organic Light-Emitting Diode (OLED) are problematic in that the positions where speakers must be placed are occupied by the display. That is, a problem arises in that, unless the display itself outputs sound or has a device characteristic such that it is penetrable by sound, sound matching each object position in the screen must be provided using speakers located outside of a display area. In FIG. 3, a minimum of speakers corresponding to Front Left center (FLc), Front Center (FC), and Front Right center (FRc) are arranged at positions overlapping the display.

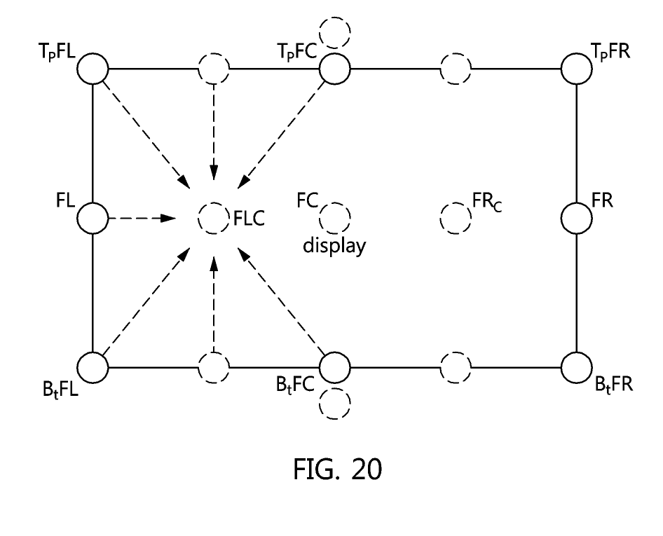

FIG. 20 is a conceptual diagram showing a concept in which sounds from speakers removed due to a display, among the speakers arranged in front positions in a 22.2 channel system, are reproduced using neighboring channels thereof. In order to cope with the absence of FLc, FC, and FRc, the case may also be considered where additional speakers, such as the circles indicated by dotted lines, may be arranged around the top and bottom portions of the display. Referring to FIG. 20, the number of neighboring channels that may be used to generate FLc may be 7.

Sounds corresponding to the positions of absent speakers may be reproduced based on the principle of creation of virtual sources using 7 such speakers.

As methods for generating virtual sources using neighboring speakers, technology or properties such as Vector Based Amplitude Panning (VBAP) or precedence effect (HAAS effect) may be used. Alternatively, depending on the frequency band, different panning techniques may be applied. Furthermore, the change of an azimuth angle and the adjustment of height using a Head Related Transfer Function (HRTF) may be taken into consideration. For example, when a speaker corresponding to a front center (FC) is replaced with a speaker corresponding to a Bottom Front center (BtFC), such a virtual source generation method may be implemented using a method of adding an FC channel signal to BtFC may be implemented using the HRTF having rising properties. A property that can be detected by observing HRTF is that the position of a specific null in a high-frequency band (differing for each person) must be controlled in order to adjust the pitch of sounds. However, in order to generalize and implement null positions, which differ for respective persons, the pitch may be adjusted using a method of widening or narrowing a high-frequency band.

If such a method is used, there is the disadvantage of causing signal distortion due to the influence of a filter.

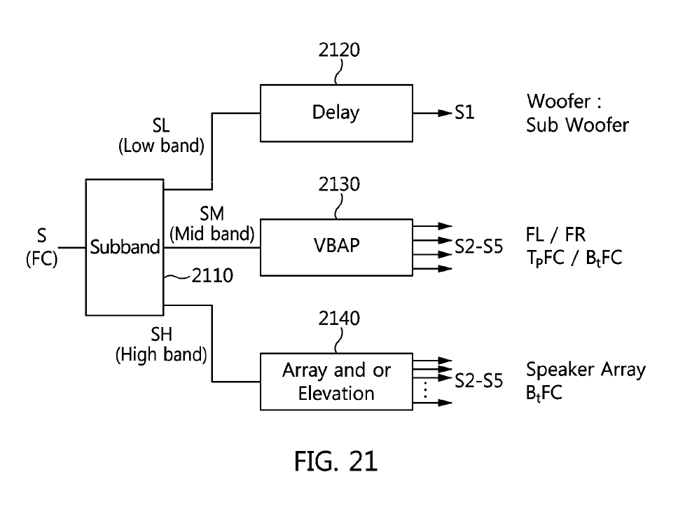

A processing method for arranging sound sources at the positions of absent (phantom) speakers according to the present invention is illustrated in FIG. 18. Referring to FIG. 21, channel signals corresponding to the positions of phantom speakers are used as input signals, and the input signals pass through a sub-band filter unit 2110 for dividing the signals into three bands. Such a method may also be implemented using a method having no speaker array. In this case, the method may be implemented in such a way as to divide the signals into two bands instead of three bands, or so as to divide the signals into three bands and process two upper bands in different manners. A first band is a low frequency band, which is relatively insensitive to position, but is preferably reproduced using a large speaker, and thus it can be reproduced via a woofer or subwoofer speaker. In this case, to use the precedence effect, a time delay 2120 is added to the first band signal. Here, the time delay is intended to provide an additional time delay so as to reproduce the corresponding signal later than other band signals, that is, to provide the precedence effect, without intending to compensate for the time delay of the filter occurring during a processing procedure in other bands.

A second band is a signal to be reproduced through speakers around phantom speakers (TV display bezel and speakers arranged around the display), and is divided among at least two speakers and reproduced. Coefficients required to apply a panning algorithm 2130 such as VBAP are generated and applied. Therefore, only when information about the number and positions of speakers, through which the output of the second band is to be reproduced (relative to phantom speakers), is precisely provided can the panning effect based on such information be improved. In this case, in order to apply a filter in consideration of HRTF or provide a time panning effect in addition to VBAP panning, different phase filters or time delay filters may also be applied. Another advantage that can be obtained when bands are divided and HRTF is applied in this way is that the range of signal distortion occurring due to HRTF may be limited to be within a processing band.

A third band is intended to generate signals to be reproduced using a speaker array when there is such a speaker array, and array signal processing technology 2140 for virtualizing sound sources through at least three speakers may be applied. Alternatively, coefficients generated via Wave Field Synthesis (WFS) may be applied. In this case, the third band and the second band may actually be identical to each other.

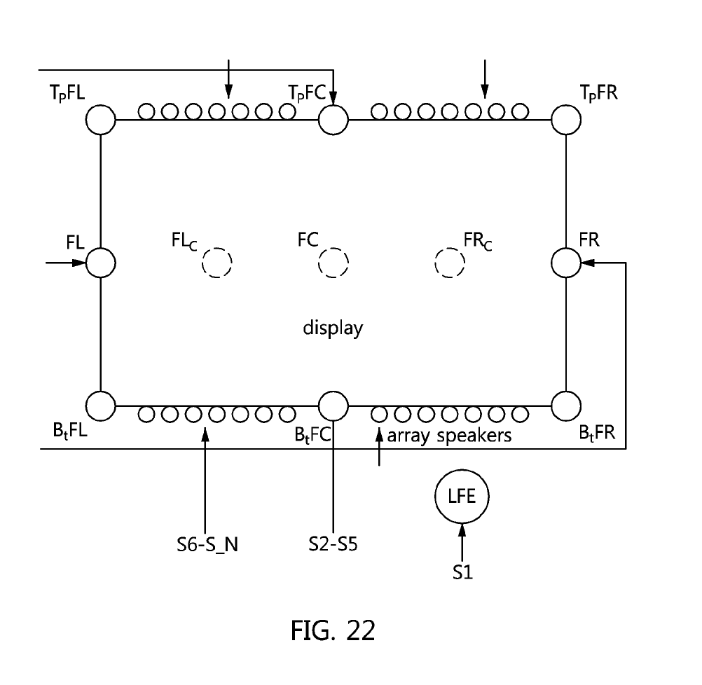

FIG. 22 illustrates an embodiment in which signals generated in respective bands are mapped to speakers arranged around a TV. Referring to FIG. 22, the number and positions of speakers corresponding to the second band and the third band must be placed at relatively precisely defined positions. The position information is preferably provided to the processing system of FIG. 21.

(Overall VOG Block Diagram)

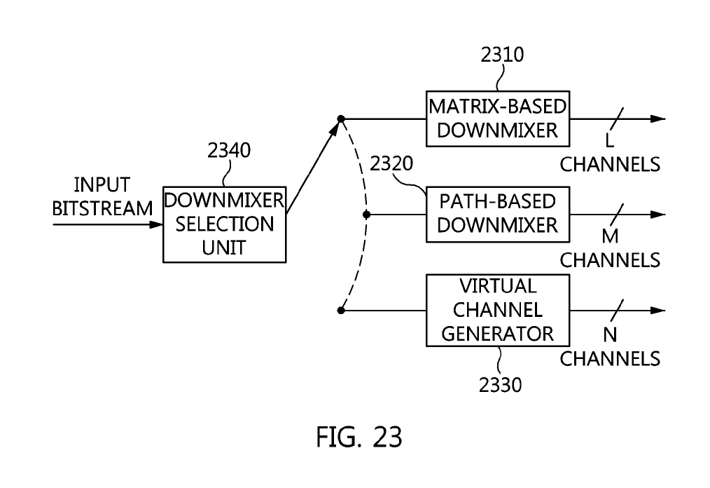

FIG. 23 is a conceptual diagram showing a procedure of downmixing a TpC signal. A TpC signal or an object signal located over a head may be downmixed by analyzing the specific value of a transmitted bitstream or the features of the signal. First, it is profitable to apply the same downmix gain to a plurality of channels for ambient signals that are stationary over the head or have ambiguous directionality. This enables object signals in or near a TcP channel to be downmixed using an existing typical matrix-based downmixer 2310. Second, in the case of TpC channel signals or object signals in a sound scene that is in motion, when the above-described matrix-based downmixer 2310 is used, the dynamic sound scene intended by a content provider becomes more static. In order to prevent this, downmixing having a variable gain value may be performed by analyzing channel signals or utilizing the meta-information of object signals. Such a downmixing device is called a path-based downmixer 2320.

Finally, when it is impossible to sufficiently obtain a desired effect using only nearby speakers, spectral cues for perceiving the height of a person may be used in the output signals of N specific speakers. Such a device is called a virtual channel generator 2330. A downmixer selection unit 2340 determines which downmixing method is to be used by exploiting input bitstream information or by analyzing input channel signals. By means of the downmixing method selected in this way, output signals are determined to be L, M or N channel signals.

(Downmix Determination Unit)

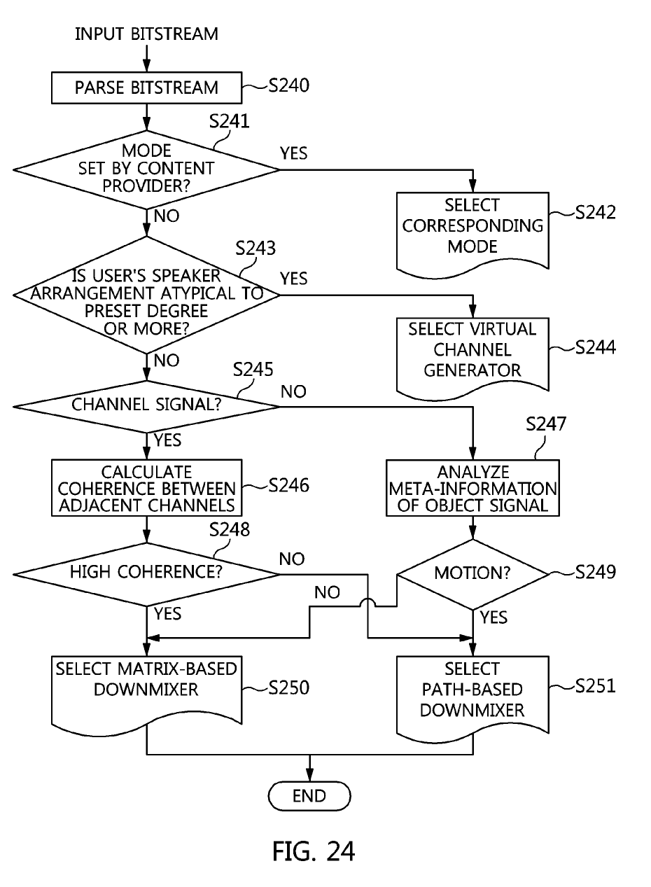

FIG. 24 is a flowchart of the downmixer selection unit 2440. First, an input bitstream is parsed (S240), and then it is checked whether a mode has been set by a content provider (S241). If a mode has been set, downmixing is performed using set parameters in the corresponding mode (S242). If no mode has been set by the content provider, the current arrangement of the user's speakers is analyzed (S243). The reason for this is that, when the arrangement of speakers is excessively atypical, it is impossible to sufficiently reproduce the sound scene intended by the content provider when performing downmixing merely by adjusting the gain values of nearby channels, as described above. In order to overcome this obstacle, several cues allowing persons to perceive sound images having a high elevation must be used.

Here, at step S243, it is determined whether the arrangement of the user's speakers is atypical to a preset degree or more. If it is determined that the arrangement is not atypical to the preset degree or more, it is determined whether a current signal is a channel signal (S245). If it is determined at step S245 that the current signal is a channel signal, coherence between adjacent channels is calculated (S246). Further, if it is determined at step S245 that the current signal is not a channel signal, the meta-information of an object signal is analyzed (S247).

After step S246, it is determined whether coherence is high (S248). If coherence is high at step S248, a matrix-based downmixer is selected (S250), whereas if coherence is not high, it is determined whether there is motion (S249). If it is determined at step S249 that there is no motion, the process proceeds to step S250, whereas if it is determined that there is motion, a path-based downmixer is selected (S251).

Meanwhile, if it is determined at step S245 that the current signal is not a channel signal, the meta-information of an object signal is analyzed (S247), and it is determined whether there is motion (S249).

As an embodiment of the analysis of speaker arrangement, the sum of the distances between the position vectors of the speakers in the top layer in FIG. 3 and the position vectors of the speakers in the top layer in a reproduction stage may be used for analysis. It is assumed that the position vector of an i-th speaker in the top layer in FIG. 2 is Vi and the position vector of an i-th speaker in the reproduction stage is Vi′. Further, assuming that a weight based on the positional importance of each speaker is wi, the speaker position error Espk may be defined by the following Equation 3:

$$Espk = {\sum }_{i} ‖ Vi - {Vi}^{′} ‖ \qquad [ Equation 3 ]$$

When the arrangement of the user's speakers is excessively atypical, the speaker position error Espk has a large value. Therefore, when the speaker position error Espk is equal to or greater than (or is greater than) a predetermined threshold value, a virtual channel generator is selected. When the speaker position error is less than (or is less than or equal to) the predetermined threshold value, the matrix-based downmixer or the path-based downmixer is used. When a sound source to be downmixed is a channel signal, a downmixing method may be selected depending on the estimated width of the sound image of the channel signal.

The reason for this is that the localization blur of a human being, which will be described later, is much greater than that of a median plane, and thus a precise sound image localization method is not necessary when the width of a sound image (apparent source width) is wide. As an embodiment of the measurement of apparent source widths in various channels, a measurement method based on interaural cross correlation between signals received by two ears is an example thereof. However, this requires a very complicated computation. Thus, if it is assumed that cross correlation between individual channels is proportional to the interaural cross correlation, the apparent source width may be estimated using a relatively low computational load by utilizing the sum of cross correlations between a TpC channel signal and individual channels.

Assuming that the TpC channel signal is a certain variable and neighboring channel signals are other variables, a method of estimating the sum C of the cross correlations between the TpC channel signal and the neighboring channel signals may be defined by the following Equation 4.

When the sum C of the cross correlations between the TpC channel signal and the neighboring channel signals is greater than (or is equal to or greater than) the predetermined threshold value, the apparent source width is wider than a reference value, and then the matrix-based downmixer is used, otherwise the apparent source width is narrower than the reference value and then a more precise path-based downmixer is used.

In contrast, in the case of an object signal, a downmixing method may be selected depending on variation in the position of the object signal. The position information of the object signal is included in meta-information that may be acquired by parsing an input bitstream. As an embodiment of the measurement of the variation in the position of the object signal, a variance or standard deviation, which is the statistical characteristic of the position of the object signal, obtained for N frames, may be used. When the measured variation in the position of the object signal is greater than (or is equal to or greater than) the predetermined threshold value, the corresponding object has a large position variation, and thus a more precise path-based downmixing method is selected. Otherwise, the corresponding object signal is regarded as a static sound source, and thus a matrix-based downmixer capable of effectively downmixing signals using a low computational load owing to the above-described human being's localization blur is selected.

(Static Sound Source Downmixer/Matrix-Based Downmixer)

In accordance with various psychoacoustic experiments, sound image localization in a median plane has an aspect completely different from that of sound image localization in a horizontal plane. The value required to measure such inaccuracy in sound image localization is localization blur, which indicates the range within which the positions of sound images cannot be identified at a specific position by angles. In accordance with the above-described experiments, audio signals have inaccuracy ranging from 9° to 17°. However, in consideration of the fact that audio signals in the horizontal plane have inaccuracy ranging from 0.9° to 1.5°, it can be seen that sound image localization in the median plane is very inaccurate.

Since, for a sound image having a high elevation, the accuracy at which a human being can perceive it is low, downmixing using a matrix is more effective than a precise localization method. Therefore, in the case of a sound image, the position of which does not greatly change, an absent TpC channel may be effectively upmixed into a plurality of channels by distributing the same gain value to the channels in the top layer, to which speakers are symmetrically distributed.

If it is assumed that the channel environment of a reproduction stage is identical in the top layer to the configuration in FIG. 3 except for the TpC channel, the channel gain values distributed to the top layer are identical to each other. However, it is well known that it is difficult for the reproduction stage to have a typical channel environment such as that shown in FIG. 3. In an atypical channel environment, distributing a uniform gain value to all of the above-described channels may result in the angle between the position of a sound image and the intended position of the content increasing above the value of localization blur. This causes the user to perceive an erroneous sound image. In order to prevent this, a procedure for compensating for such an error is required in an atypical channel environment. In the case of a channel located in the top layer, it may be assumed that an audio signal has reached in the form of a plane wave at the position of a listener, and thus an existing downmixing method for setting a uniform gain value may be described as reproducing a plane wave produced from a TpC channel using neighboring channels. The center of gravity of a polygon having, as vertices, the positions of speakers in the plane including the top layer may be regarded as being consistent with the position of the TpC channel. Therefore, in the atypical channel environment, the gain values of respective channels may be obtained from a formula indicating that the center of gravity of 2D position vectors of respective channels, to which the gain values are assigned as weights, in the plane including the top layer is consistent with a position vector at the TpC channel position.

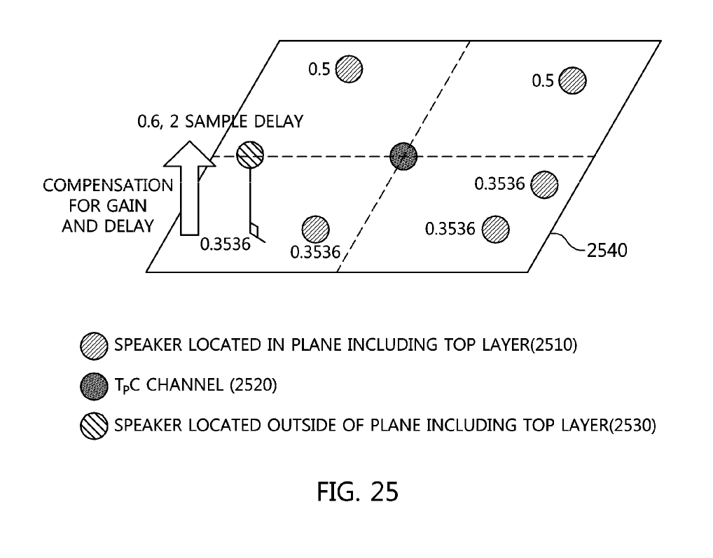

However, such a formula-based approach requires a high computational load, and the performance thereof is not greatly different from that of a simplified method, which will be described below. Such a simplified method is described as follows. First, an area around the TpC channel is divided into N equiangular areas. A uniform gain value is assigned to the equiangular areas, and is set such that, when two or more speakers are located in each area, the sum of the squares of respective gains is identical to the above-described gain value. As an embodiment of this case, it is assumed that speakers are arranged as shown in FIG. 25, and the area around a TpC channel 2520 is divided into four equiangular areas of 90°. Gain values that have the same magnitude and cause the sum of the squares thereof to be ‘1’ are assigned to the respective areas. In this case, since four areas are present, the gain value of each area is 0.5. When two or more speakers are present in one area, the gain values are set such that the sum of the squares thereof becomes identical to the gain value of the area. Therefore, the gain values of two speaker outputs present in a lower right area 2540 are 0.3536. Finally, for a speaker 2530 located outside of the plane including the top layer, the gain value appearing when the speaker is projected onto the plane including the top layer is first obtained, and the difference in the distance between the plane and the speaker is compensated for using both the gain value and a delay.

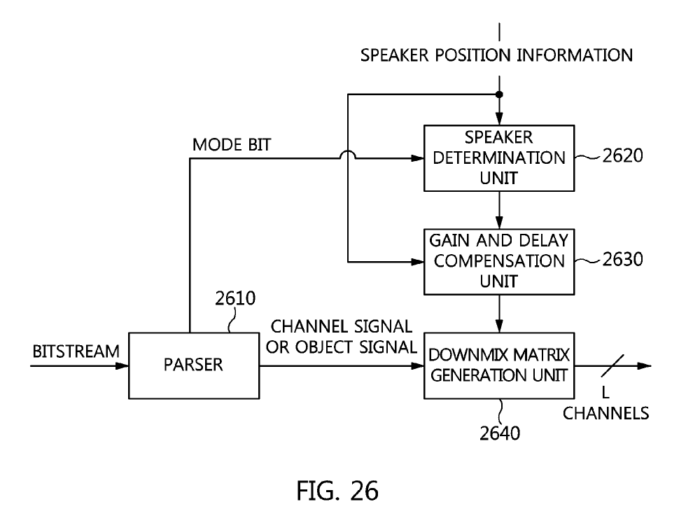

FIG. 26 is a conceptual diagram of the matrix-based downmixer 2310. First, by using a parser 2610, an input bitstream is separated into a mode bit provided by a content provider and a channel signal or an object signal. When the mode bit is set, a speaker determination unit 2620 selects the corresponding speaker group, whereas when a mode bit is not set, the speaker group having the shortest distance is selected using the position information of speakers currently used by a user. In order for a gain and delay compensation unit 2630 to compensate for the difference in distance between the selected speaker group and the actual arrangement of the user's speakers, the gains and delays of the respective speakers are compensated for. Finally, a downmix matrix generation unit 2640 downmixes the channel or object signal output from the parser into other channels by applying the gains and delays output from the gain and delay compensation unit 2630 to the channel or object signal.

(Dynamic Sound Source Downmixer/Path-Based Downmixer)

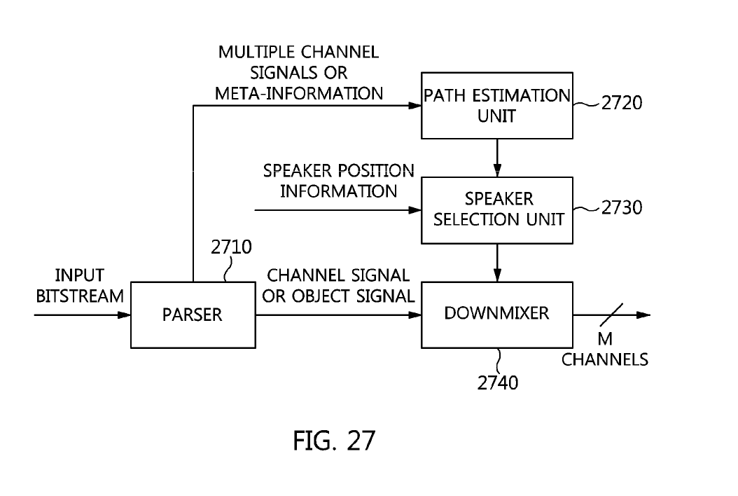

FIG. 27 is a conceptual diagram of a dynamic sound source downmixer 2320. First, a parser 2710 parses an input bitstream, and transfers a plurality of channel signals, for a TcP channel signal, and meta-information, for an object signal, to a path estimation unit 2720. For the plurality of channel signals, the path estimation unit 2720 estimates correlations between channels, and estimates variation in the channels having high correlation as a path. In contrast, for meta-information, variation in the meta-information is estimated as a path. A speaker selection unit 2730 selects speakers located within a predetermined distance from the path estimated by the path estimation unit 2720. The position information of the speakers selected in this way is sent to a downmixer 2740 and then the channel or object signal is downmixed in conformity with the corresponding speakers. As an example of a downmixing method, vector-based amplitude panning (VBAP) is presented.

(Detent Effect)

If a sound source that is continuously moving along a specific path is localized using an amplitude panning method such as VBAP, a detent effect occurs. The detent effect denotes a phenomenon in which, when a sound image is localized between speakers using an amplitude panning method, the sound image is not formed at an exact position, but is pulled closer to the speakers. Due to this phenomenon, when a sound image is continuously moved between speakers, it is shifted not continuously but discontinuously.

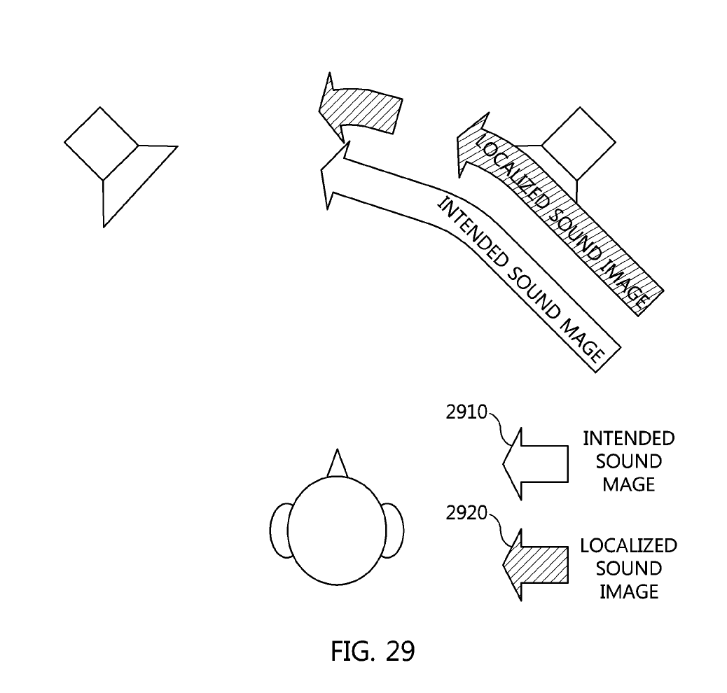

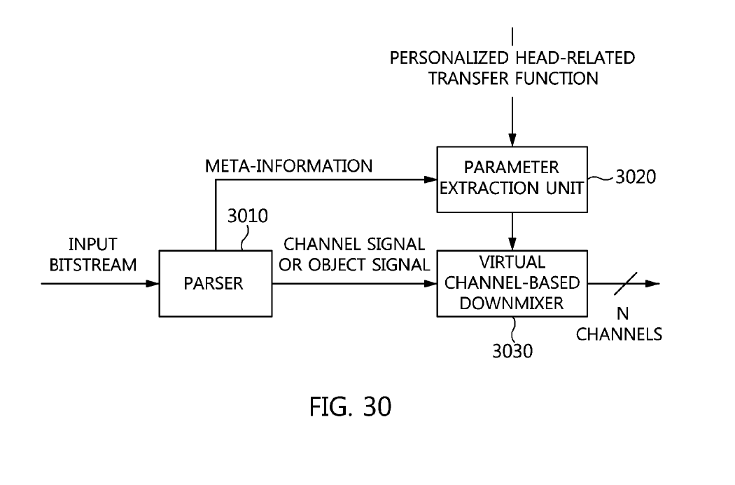

FIG. 29 is a conceptual diagram showing the detent effect. If an intended sound image 2910 is moved in the direction of the arrow over time, the sound image is moved like a localized sound image 2920 when being localized using a typical amplitude panning method. Due to the detent effect, the sound image is pulled closer to a speaker and is not greatly moved. When the azimuth angle of the sound image exceeds a predetermined threshold value, the sound image is moved, as shown in FIG. 29. This problem causes the sound image to be formed at a slightly different position as only a sound image localization error when the sound image is located for a predetermined period of time, and thus the user does not feel it as great distortion. However, when a sound image is suddenly and discontinuously moved due to the detent effect in an environment in which the sound image must be continuously moved, the user may perceive such a movement as great distortion.

In order to solve this problem, a continuously moving sound source must be detected, and correct compensation based on the detected sound source must be performed. As the simplest method, there is a method of further pulling a sound source that was insufficiently pulled by applying a weighting function to a panning gain.

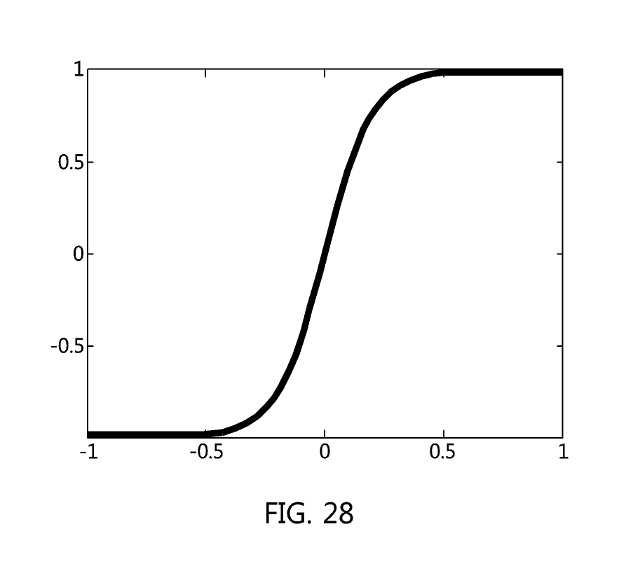

FIG. 28 is a graph showing an example of a weighting function.

Referring to FIG. 28, as an example of a weighting function, the output of a specific sigmoid function is illustrated when an input changes within the range from −1 to 1. It can be seen that when the output value is closer to 0, variation in the value is increased. Therefore, as a sound image is farther away from the speaker, variation in the value of the panning gain is increased further, thus enabling effective compensation for insufficient pulling of the existing sound image. The above sigmoid function is an example, and such a function may include all functions that cause variation in the value to be larger as the function value becomes closer to 0 or as the sound image becomes closer to the point at which the distances to the sound image and to the speaker are identical. In addition, such a detent effect is exhibited to a different degree for each person.

Therefore, variation in the weighting function or the like may be modeled and applied using the physiological features of a person, for example, information such as the size of the head, the size of the body, height, weight, and the shape of the external ear.

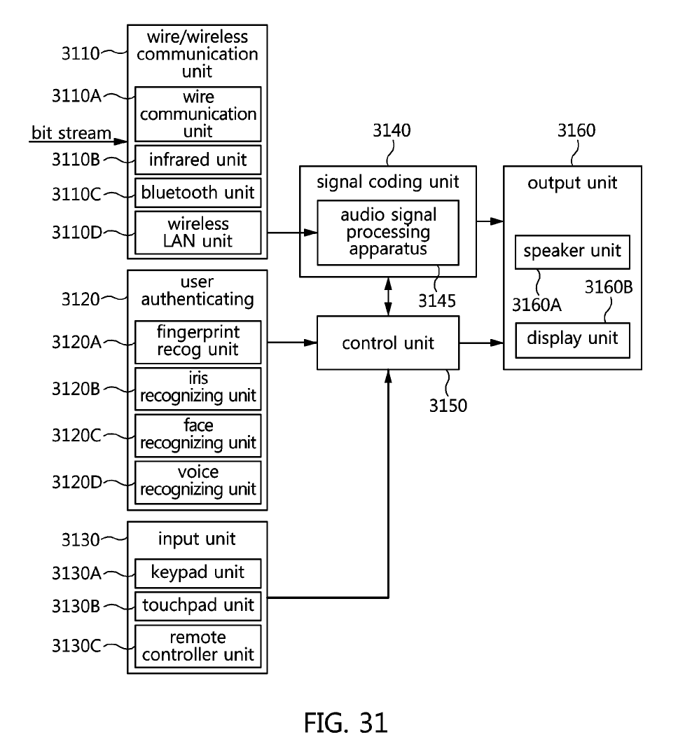

FIG. 31 is a diagram showing the relationship between products in which the audio signal processing device is implemented according to an embodiment of the present invention. Referring to FIG. 31, a wired/wireless communication unit 3110 receives bitstreams in a wired/wireless communication manner. More specifically, the wired/wireless communication unit 3110 may include one or more of a wired communication unit 3110A, an infrared unit 3110B, a Bluetooth unit 3110C, and a wireless Local Area Network (LAN) communication unit 3110D.

A user authentication unit 3120 receives user information and authenticates a user, and may include one or more of a fingerprint recognizing unit 3120A, an iris recognizing unit 3120B, a face recognizing unit 3120C, and a voice recognizing unit 3120D, which respectively receive fingerprint information, iris information, face contour information, and voice information, convert the information into user information, and determine whether the user information matches previously registered user data, thus performing user authentication.

An input unit 3130 is an input device for allowing the user to input various types of commands, and may include, but is not limited to, one or more of a keypad unit 3130A, a touch pad unit 3130B, and a remote control unit 3130C.

A signal coding unit 3140 performs encoding or decoding on audio signals and/or video signals received through the wired/wireless communication unit 3110, and outputs audio signals in a time domain. The signal coding unit 3140 may include an audio signal processing device 3145. In this case, the audio signal processing device 3145 and the signal coding unit including the device may be implemented using one or more processors.

A control unit 3150 receives input signals from input devices and controls all processes of the signal decoding unit 3140 and an output unit 3160. The output unit 3160 is a component for outputting the output signals generated by the signal decoding unit 3140, and may include a speaker unit 3160A and a display unit 3160B. When the output signals are audio signals, they are output through the speakers, whereas when the output signals are video signals, they are output via the display unit.

The audio signal processing method for sound image localization according to the present invention may be realized in a program to be executed on a computer and stored in a computer-readable storage medium. Multimedia data having a data structure according to the present invention may also be stored in a computer-readable storage medium. The computer-readable recording medium includes all types of storage devices that are readable by a computer system. Examples of a computer-readable storage medium include Read Only Memory (ROM), Random Access Memory (RAM), Compact Disc ROM (CD-ROM), magnetic tape, a floppy disc, an optical data storage device, etc., and may include the implementation in the form of a carrier wave (for example, via transmission over the Internet). Further, the bitstreams generated by the encoding method may be stored in the computer-readable medium, or may be transmitted over a wired/wireless communication network.

As described above, although the present invention has been described with reference to limited embodiments and drawings, it is apparent that the present invention is not limited to such embodiments and drawings, and the present invention may be changed and modified in various manners by those skilled in the art to which the present invention pertains without departing from the technical spirit of the present invention and equivalents of the accompanying claims.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

Further, upon describing the components of the present invention, terms such as first, second, A, B, (a), and (b) may be used. Those terms are used to merely distinguish the corresponding component from other components, and the essential feature, sequence or order of the corresponding component is not limited by the terms.

What is claimed is:

1. An audio signal processing method for sound image localization, comprising:
receiving a bitstream including an object signal of audio and object position information of the audio;
decoding the object signal and the object position information using the received bitstream;
receiving past object position information that is object position information in past, corresponding to the object position information, from a storage medium;
generating an object moving path using the received past object position information and the decoded object position information;
generating a variable gain value over time using the generated object moving path;
generating a corrected variable gain value using the generated variable gain value and a weighting function; and
generating a channel signal from the decoded object signal using the corrected variable gain value.

2. The audio signal processing method for sound image localization according to claim 1, wherein the weighting function varies based on a user's physiological feature.

3. The audio signal processing method for sound image localization according to claim 2, wherein the physiological feature is extracted using an image or a video.

4. The audio signal processing method for sound image localization according to claim 2, wherein the physiological feature comprises information about at least one of a size of the user's head, a size of the user's body, and a shape of the user's external ear.
